(19) United States
(12) Patent Application Publication
(10) Pub. No.: US 2026/0300785 A1
(43) Pub. Date: Oct. 1, 2026

(54) UNARY DIFFERENTIATION OF COMPOSITIONS

(71) Applicant: Thermo Scientific Portable Analytical Instruments Inc., Tewksbury, MA (US)

(72) Inventors: Rafet Maltas, Tewksbury, MA (US); Lin Zhang, Andover, MA (US)

(21) Appl. No.: 19/539,591

(22) Filed: Feb. 13, 2026

Related U.S. Application Data
(60) Provisional application No. 63/777,224, filed on Mar. 25, 2025.

(51) Int. Cl. G06N 7/01

(52) U.S. Cl. CPC G06N 7/01

(57) ABSTRACT

Systems/techniques are provided for facilitating unary differentiation of compositions. In various embodiments, a system can comprise a processor that can execute computer-executable components stored in a non-transitory computer-readable memory. In various instances, the computer-executable components can comprise a conversion component that generates one or more binary features based on a set of transformed peaks of a sample spectrum, the sample spectrum associated with a sample of interest. In various cases, the computer-executable components can further comprise an identification component that that determines a probability parameter for the sample of interest based on the one or more binary features, wherein the probability parameter is associated with a first target composition.

This application claims priority to and the benefit of U.S. Provisional Application No. 63/777,224, entitled “UNARY DIFFERENTIATION OF COMPOSITIONS,” which was filed on Mar. 25, 2025. The aforementioned application is hereby incorporated herein by reference in its entirety.

### BACKGROUND

Various scientific instruments can generate or capture spectral data. The resulting spectrum can be analyzed to identify a composition. However, differentiating compositions with similar spectrums to identify a sample can be difficult.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate unary differentiation of compositions are described.

According to one or more embodiments, a system is provided. In various aspects, the system can comprise a processor that can execute computer-executable components stored in a non-transitory computer-readable memory. In various instances, the computer-executable components can comprise a conversion component that generates one or more binary features based on a set of transformed peaks of a sample spectrum, the sample spectrum associated with a sample of interest. In various cases, the computer-executable components can comprise an identification component that determines a probability parameter for the sample of interest based on the one or more binary features, wherein the probability parameter is associated with a first target composition.

According to one or more embodiments, a computer-implemented method is provided. In various embodiments, the computer-implemented method can comprise generating, by a device operatively coupled to a processor, one or more binary features based on a set of transformed peaks of a sample spectrum, the sample spectrum associated with a sample of interest. In various aspects, the computer-implemented method can comprise determining, by the device, a probability parameter for the sample of interest based on the one or more binary features, wherein the probability parameter is associated with a first target composition.

According to one or more embodiments, a computer program product for facilitating unary differentiation of compositions is provided. In various embodiments, the computer program product can comprise a non-transitory computer-readable memory having program instructions embodied therewith. In various aspects, the program instructions can be executable by a processor to cause the processor to generate one or more binary features based on a set of transformed peaks of a sample spectrum, the sample spectrum associated with a sample of interest. In various instances, the program instructions can be executable to cause the processor to determine a probability parameter for the sample of interest based on the one or more binary features, wherein the probability parameter is associated with a first target composition.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates unary differentiation of compositions in accordance with one or more embodiments described herein.

FIG. 4 illustrates an example, non-limiting block diagram of a computing device that can perform some or all of the methods or techniques disclosed herein, in accordance with various embodiments described herein.

FIG. 5 illustrates a block diagram of an example, non-limiting system that facilitates unary differentiation of compositions in accordance with one or more embodiments described herein.

FIG. 6 illustrates an example, non-limiting diagram showing two compositions with similar spectral features in accordance with one or more embodiments described herein.

FIG. 7 illustrates an example, non-limiting block diagram showing how a spectrometer can produce a spectrum of a sample in accordance with one or more embodiments described herein.

FIG. 8 illustrates an example, non-limiting block diagram showing how a transformed sample spectrum can be obtained in accordance with one or more embodiments described herein.

FIG. 9 illustrates an example, non-limiting diagram showing application of Savitzky-Golay transformation in accordance with one or more embodiments described herein.

FIG. 10 illustrates an example, non-limiting block diagram showing how binary features can be generated in accordance with one or more embodiments described herein.

FIG. 11 illustrates an example, non-limiting diagram showing application of Savitzky-Golay transformation in accordance with one or more embodiments described herein.

FIG. 12 illustrates a flow diagram of example, non-limiting method that can facilitate unary differentiation of compositions in accordance with one or more embodiments described herein.

FIG. 13 illustrates a flow diagram of example, non-limiting method that can facilitate unary differentiation of compositions in accordance with one or more embodiments described herein.

FIGS. 14-16 illustrate example, non-limiting experimental results in accordance with one or more embodiments described herein.

FIG. 17 illustrates a flow diagram of example, non-limiting method that can facilitate unary differentiation of compositions in accordance with one or more embodiments described herein.

FIG. 18 illustrates an example, non-limiting block diagram of a scientific instrument support system in which some or all of the methods or techniques disclosed herein may be performed, in accordance with various embodiments described herein

FIG. 19 illustrates a block diagram of an example, non-limiting operating environment in which one or more embodiments described herein can be facilitated.

FIG. 20 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

Spectroscopy involves measuring how matter absorbs, emits, or scatters light (or other forms of electromagnetic radiation) across different wavelengths. The resulting spectral data (e.g., spectra) can provide information about the composition, structure, or properties of a composition. Accordingly, it can be desirable to use measured spectra of a sample to identify or verify a composition thereof.

Existing methods for using measured spectra of a composition to identify a composition or verify its identification typically involve analyzing features of the spectra. For example, existing techniques may involve comparing characteristic peaks in an unidentified spectrum to a spectrum of known composition to identify or verify a composition. As another example, existing techniques involve comparing overall shape of a spectrum to spectrum of known compositions to identify or verify a composition.

However, when identifying or verifying a composition using measured spectra, differentiating the composition from various known compositions can be challenging when compositions share similar spectral features. That is, spectra of different compositions can exhibit several similarities, posing difficulties for existing methods to differentiate a composition between the various compositions. For instance, spectra of different compositions can exhibit peaks at similar or closely located wavenumbers. Furthermore, this challenge is exacerbated when identifying a composition at low concentrations. Thus, analyzing features such as characteristic peaks or overall shape of a composition's spectra can lead to misidentification or uncertainty in identification of the composition. In other words, these features can be unreliable indicators for identifying or verifying the composition.

Enhancing signal quality of a sample spectrum may mitigate some of the abovementioned issues associated with composition identification. For example, in Raman spectroscopy, Surface-Enhanced Raman Scattering (SERS) can be employed to amplify Raman signals by enhancing the electromagnetic field and increasing the intensity of the scattered light. However, these techniques, such as SERS, can further complicate the differentiating process by altering the intensity of certain peaks in the sample's spectra. For example, applying SERS can introduce additional noise into the spectrum produced thereby. Consequently, misidentification or uncertainty in identification of a composition can still occur.

Additionally, existing methods may fail to accurately identify an individual composition within a mixture. More specifically, such existing methods typically analyze a spectrum as a whole, without accounting for the contributions of individual components in a complex mixture. This approach can lead to misinterpretation of the spectral data, as overlapping peaks from different compositions may combine to create a spectrum that does not accurately represent any single component. Consequently, the nuances of each composition's spectral features, such as peak intensities, may be obscured, making it challenging for existing methods to determine the presence of an individual composition.

Further, another limitation of existing methods for differentiating between compositions is their reliance on comparing known reference spectra for identification. For example, accurate composition identification relies on known library spectra (e.g., high-quality reference spectra) of various compositions to identify a composition. Such dependence can be problematic, especially when a library spectrum of a composition is inaccessible or unavailable when identifying (e.g., absent from a spectral database).

Thus, existing techniques can be considered as being insufficiently reliable. Accordingly, systems or techniques that can ameliorate one or more of these technical problems can be desirable.

Various embodiments described herein can address one or more of these technical problems. One or more embodiments described herein can include systems, computer-implemented methods, apparatus, or computer program products that can facilitate unary differentiation of compositions. In particular, as mentioned above, different compositions can be spectrally similar, causing difficulty in identifying a sample between the spectrally similar compositions (e.g., difficult to determine if it is one composition or another spectrally similar composition). Thus, it can be desirable to identify a sample between a first target composition and a first target composition that are spectrally similar. To achieve this, the various embodiments described herein can apply a transformation to a sample spectrum. That is, a sample spectrum can be transformed using a Savitzky-Golay (SG) transformation to reduce noise (e.g., SERS noise) while creating transformed peaks that are representative of peaks in the untransformed sample spectrum. Thereafter, the transformed peaks of the sample spectrum can be converted to relative ratios in relation to transformed peaks of a library spectrum of the first target composition. The relative ratios can then be converted to binary features based on thresholds of the relative ratios, of which identification if the sample contains the first target composition can be based upon.

Prior to application, the various embodiments described herein can undergo a training phase. During the training phase, the various embodiments described herein can determine the thresholds of the relative ratios using training spectra of the first target composition and the second target composition. Thresholds can be determined for the first target composition, and thresholds can be determined for the second target composition. In other words, each of the target compositions can have corresponding thresholds. Thus, the various embodiments described herein can be used to identify if the sample contains the first target composition using its corresponding thresholds, and/or the to identify if the sample contains the second target composition using its corresponding thresholds. This can enable the identification of spectrally similar compositions in mixtures by allowing a unary identification of each of the target compositions. Moreover, following the training phase, the various embodiments described herein do not require access to the library spectrum of the target compositions during application to differentiate a sample between the target compositions (e.g., when identifying or verifying a sample in the field).

For at least these reasons, various embodiments described herein can be considered as a concrete and tangible technical improvement in the field of composition identification or differentiation. Accordingly, various embodiments described herein certainly qualify as useful and practical applications of computers.

Various embodiments described herein can be considered as a computerized tool (e.g., any suitable combination of computer-executable hardware or computer-executable software) that can facilitate unary differentiation of compositions. In various aspects, such computerized tool can comprise a conversion component, an identification component, a training component, or a transformation component.

In various embodiments, there can be a scientific instrument. In various aspects, the scientific instrument can be any suitable computerized device that can electronically capture or generate a spectrum of a sample. As a non-limiting example, the scientific instrument can be a spectrometer.

In various instances, it can be desired to analyze the spectrum to identify or verify a presence of a first target composition in the sample against a second target composition that may be spectrally similar. In various cases, the computerized tool described herein can facilitate such identification or analysis.

In various embodiments, the transformation component of the computerized tool can electronically access or receive the spectrum of the sample. In various aspects, the transformation component can apply a transformation to the spectrum of the sample, yielding a transformed sample spectrum. Additionally, the transformation component can apply the transformation to a library spectrum of the first target composition, yielding a transformed library spectrum of the first target composition. Particularly, the transformation can be a Savitzky-Golay (SG) transformation. The SG transformation can produce transformed spectra that exhibit reduced noise and transformed peaks that are representative of peaks in the spectrum of the sample.

In various instances, the conversion component of the computerized tool can electronically generate sample ratios of transformed peaks in the transformed sample spectrum. Specifically, each sample ratio can be associated with a height of a transformed peak. Likewise, the conversion component can electronically generate library ratios of transformed peaks in the transformed library spectrum of the first target composition, where library sample ratio can be associated with a height of a transformed peak. Based on the sample ratios and the library ratios, the conversion component can generate relative ratios. In other words, for any sample received, the conversion component can generate relative ratios based on the transformed sample spectrum relative to the transformed library spectrum of the first target composition. In various aspects, the conversion component can generate a relative ratio for each transformed peak.

In various embodiments, the conversion component can generate one or more binary features based on the relative ratios meeting (e.g., satisfying) thresholds. Specifically, the conversion component can assign a value of 1 to a binary feature if the relative ratio corresponding to a transformed peak meets the threshold. Conversely, the conversion component can assign a value of 0 to the binary feature if the relative ratio corresponding to the transformed peak does not meet the threshold.

In various instances, based on the one or more binary features, the identification component of the computerized tool can dynamically update a probability parameter associated with the first target composition. That is, the probability parameter can be defined as a probability that the sample contains the first target composition. In various aspects, the identification component can sum the one or more binary features to determine the probability parameter. Specifically, the probability parameter can have an initial probability (e.g., a prior probability) of 50% (e.g., when differentiating between two target compositions). As the identification component receives the one or more binary features and their value assignments, the identification component can dynamically update the probability parameter based on conditional probabilities that correspond to the first target composition.

Thereafter, the identification component can identify or verify if the sample contains the first target composition based on the probability parameter that results after updating based on the one or more binary features. More specifically, identification component can identify or verify if the sample contains the first target composition based on a sum of the one or more binary features. For example, the identification component can identify or verify that the sample contains the first target composition if the probability parameter is above 50%, and can identify or verify that the sample does not contain the first target composition if the probability parameter is below 50%.

In various aspects, the thresholds and the conditional probabilities can be predetermined during a training phase. In various embodiments, the training component of the computerized tool can facilitate such training phase.

In various embodiments, the training component can generate the thresholds using an entropy method on relative ratios determined for training spectra of the first target composition and the second target composition. More specifically, similarly to how the relative ratios are generated for the sample, the training component can generate relative ratios for the training spectrum of the first target composition. Likewise, the training component can generate relative ratios for the training spectrum of the second target composition. To generate the relative ratios for the training spectrum of the second target composition, the training component can electronically access or receive a library spectrum of the second target composition. Accordingly, the training component can employ the entropy method between the relative ratios for the training spectrum of the first target composition and the relative ratios for the training spectrum of the second target composition. By employing the entropy method to generate the thresholds, the thresholds can enable a more accurate separation power in identifying if the sample contains the first target composition.

In various instances, the training component can generate thresholds and conditional probabilities that correspond to the second target composition. By doing so, the computerized tool can instead use the thresholds and conditional probabilities that correspond to the second target composition to identify if the sample contains the second target composition.

Additionally, since the training component determines the library ratios for the first target composition and the second target composition in the training phase, the training component can store the library ratios for subsequent access when identifying a sample. For example, to determine if a sample contains the first target composition, the conversion component can access the library ratios corresponding to the first target composition to generate the relative ratios for the sample. In other instances, to determine if a sample contains the second target composition, the conversion component can access the library ratios corresponding to the second target composition to generate the relative ratios for the sample.

In any case, various embodiments described herein can be considered as facilitating unary differentiation of compositions.

Various embodiments described herein can be employed to use hardware or software to solve problems that are highly technical in nature (e.g., to facilitate unary differentiation of compositions), that are not abstract and that cannot be performed as a set of mental acts by a human. Further, some of the processes performed can be performed by a specialized computer (e.g., spectrometer) for carrying out defined acts related to differentiation of compositions.

For example, such defined acts can include: accessing, by a device operatively coupled to a processor, a spectrum of a sample produced by a spectrometer; applying, by the device, an SG transformation to the spectrum of the sample, yielding a transformed sample spectrum; and applying, by the device, an SG transformation to a library spectrum of a first target composition, yielding a transformed library spectrum. In various aspects, such defined acts can further include: determining, by the device, sample ratios of the transformed sample spectrum; determining, by the device, library ratios of the transformed library spectrum; and generating, by the device, relative ratios based on the sample ratios and library ratios. In various embodiments, such defined acts can further include: converting, by the device, the relative ratios to binary features based on the relative ratios meeting thresholds; and identifying, by the device, if the sample contains the first target composition based on the binary features.

Such defined acts are inherently computerized. Indeed, spectrometers are highly-technical computerized devices comprising specific computerized hardware (e.g., light emitters, adjustable apertures, adjustable mirrors, beamsplitters, photodetectors). Neither spectrometers nor the operations that they perform can be implemented by the human mind, or by a human with pen and paper, in any reasonable or practicable way without computers (e.g., neither the human mind nor a human with pen and paper can emit, split, or recombine light beams so as to generate spectra; neither the human mind nor a human with pen and paper can transform peaks in a spectrum).

Such defined acts are inherently computerized. Indeed, a scientific instrument, such as a spectrometer, is a highly-technical computerized device comprising specific computerized hardware (e.g., light emitters, adjustable apertures, adjustable mirrors). A scientific instrument and the operations that it performs cannot be implemented by the human mind, or by a human with pen and paper, in any reasonable or practicable way without computers. Furthermore, a spectrum is a specific type of data representation, where each data point corresponds to a measured energy distribution across different wavelengths. A spectrum cannot be generated or captured by the human mind, or by a human with pen and paper, in any reasonable or practicable way without computers.

Moreover, various embodiments described herein can integrate into a practical application various teachings relating to spectrometry and composition identification. As explained above, a spectrometer can generate a spectrum for a sample, and evaluation or analysis of that spectrum can lead to identification of the chemical composition of the sample. However, the sample can be misidentified when differentiating between compositions with similar spectral features. The present inventors recognized that existing techniques that facilitate such differentiation can be inaccurate and unreliable (e.g., prone to misidentification).

Furthermore, various embodiments described herein can control real-world tangible devices based on the disclosed teachings. For example, various embodiments described herein can electronically activate, deactivate, or otherwise actuate real-world hardware (e.g., light sources) of real-world scientific instruments (e.g., spectrometers), perform real-world analyses on real-world data captured by those real-world scientific instruments (e.g., compute transformed peaks of spectra, generate one or more binary features of the spectra, compute a probability parameter associated with the first target composition. That is, the probability parameter can be defined as a probability that the sample contains the first target composition), and can electronically render the results of such real-world analyses on real-world computer screens (e.g., can visually render an identification of the sample or a composition in the sample).

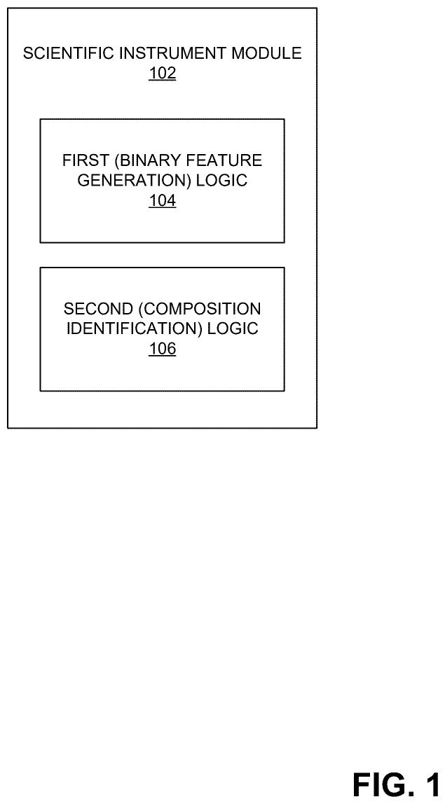

FIG. 1 illustrates an example, non-limiting block diagram of a scientific instrument module 102 in accordance with various embodiments described herein.

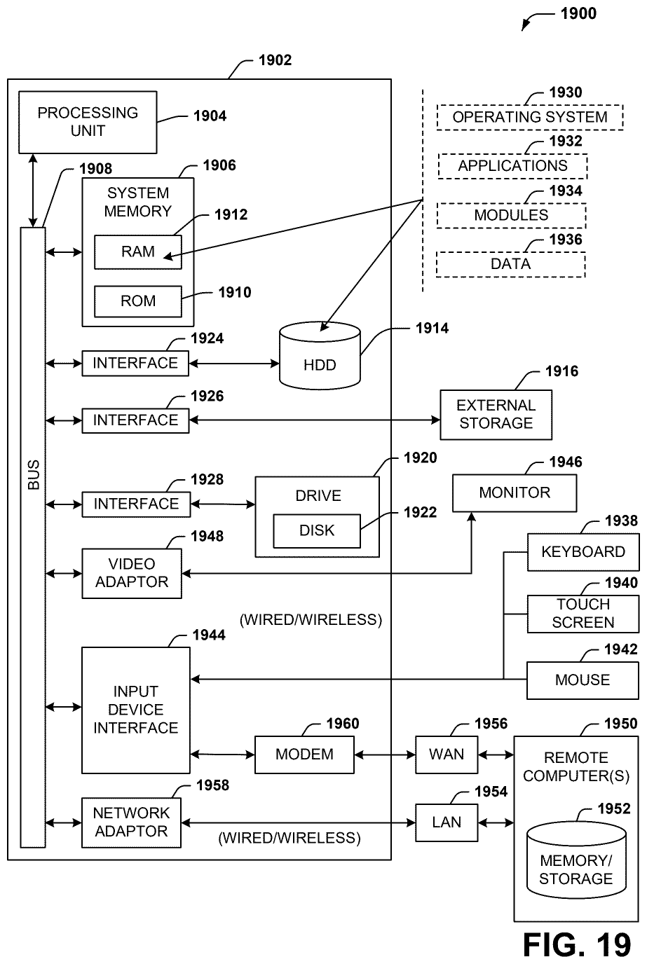

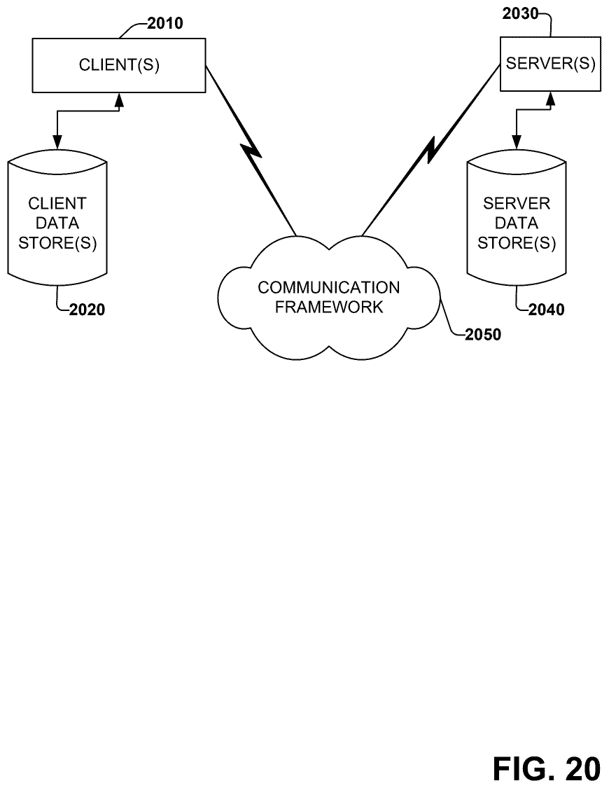

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 19, and examples of systems or networks of interconnected computing devices, in which the scientific instrument module 102 may be implemented across one or more of the computing devices, are discussed herein with reference to FIG. 20.

The scientific instrument module 102 can include first logic 104 and second logic 106. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of a sample (e.g., of a known or unknown mixture, compound, or collection of matter). As a non-limiting example, the scientific instrument can be a spectrometer. In such case, the scientific instrument can measure or capture spectrum of the sample.

In various embodiments, the first logic 104 can generate one or more binary features based on a set of transformed peaks of the spectrum of the sample. Specifically, the first logic 104 can electronically access or otherwise establish electronic communication with the scientific instrument. Thereafter, the first logic 104 can cause the scientific instrument to scan the sample, yielding the spectrum of the sample. In various aspects, the first logic 104 can apply a transformation to the spectrum. Such transformation can result in a transformed spectrum of the sample that contains a set of transformed peaks. Accordingly, based on the set of transformed peaks, the first logic 104 can generate the one or more binary features. In various embodiments, the set of transformed peaks can comprise n transformed peaks for any suitable positive integer n>2.

In various embodiments, the second logic 106 can identify if the sample is a first composition based on the one or more binary features. In various instances, the second logic 106 can use the one or more binary features to verify if the sample is a target composition. As a non-limiting example, if the target composition is methamphetamine, the second logic 106 can identify if the sample is methamphetamine or not based on the one or more binary features of the spectrum of the sample.

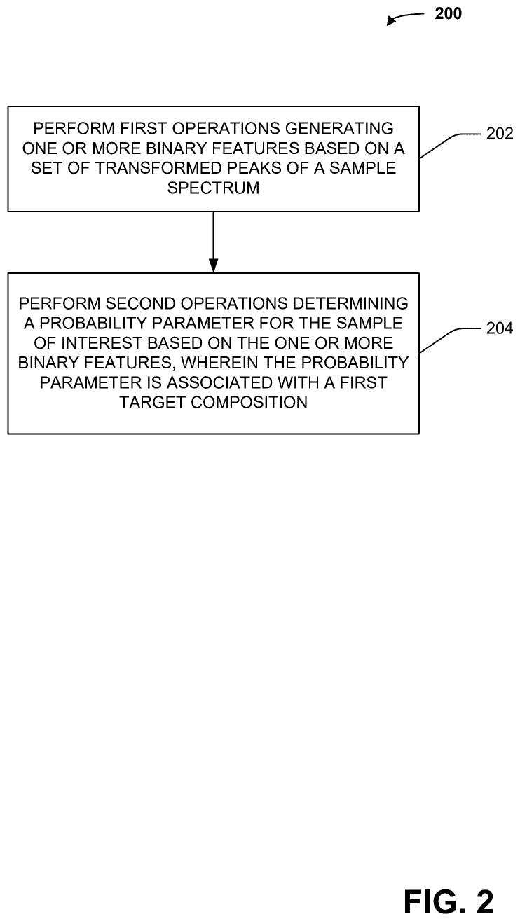

FIG. 2 is an example, non-limiting flow diagram of a computer-implemented method 200 in accordance with various embodiments described herein. The operations of the computer-implemented method 200 may be used in any suitable setting to perform any suitable operations (e.g., can be performed by or used in conjunction with any of the various modules, computing devices, or graphical user interfaces described with respect to of FIG. 1, 19, or 20). Operations are illustrated once each and in a particular order in FIG. 2, but the operations may be reordered or repeated as desired and appropriate (e.g., different operations performed may be performed in parallel, as suitable).

In various aspects, act 202 can include performing first operations generating one or more binary features based on a set of transformed peaks of a sample spectrum. In various instances, the sample spectrum can be associated with a sample of interest. In various cases, the first logic 104 can perform or otherwise facilitate act 202.

In various instances, act 204 can include performing second operations determining a probability parameter for the sample of interest based on the one or more binary features, wherein the probability parameter is associated with a first target composition. In various cases, the second logic 106 can perform or otherwise facilitate act 204.

Accordingly, the computer-implemented method 200 can facilitate unary differentiation of compositions.

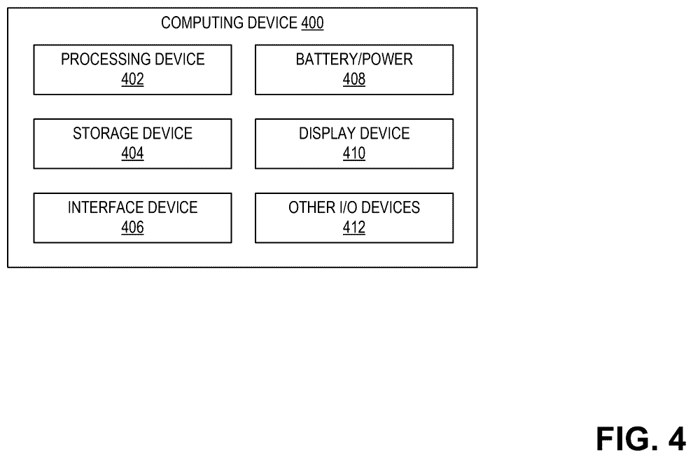

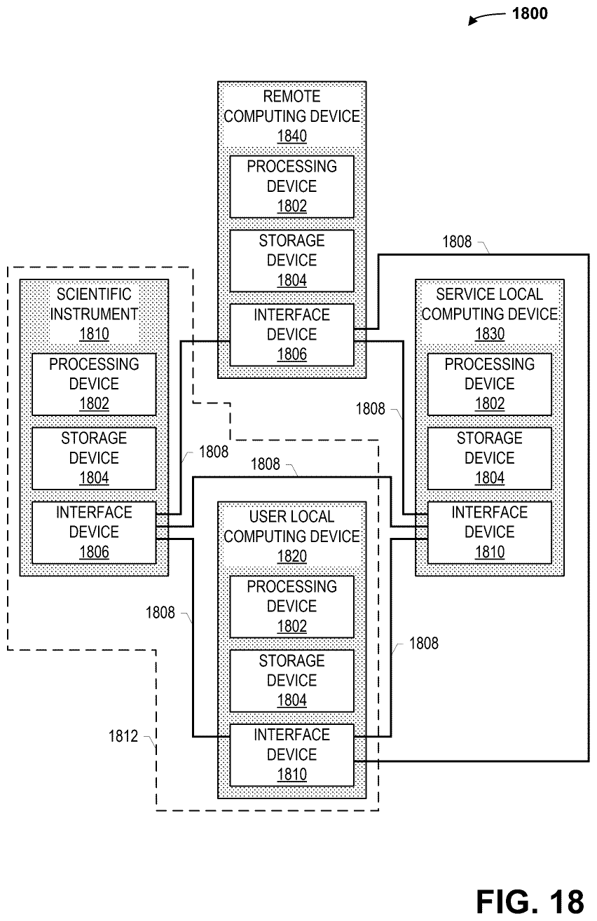

The scientific instrument methods disclosed herein can include interactions with a user entity (e.g., via the user local computing device 1820 discussed herein with reference to FIG. 18). These interactions can include providing information to the user entity (e.g., information regarding the operation of a scientific instrument such as the scientific instrument 1810 of FIG. 18, information regarding a sample being analyzed or other test or measurement performed by a scientific instrument, information retrieved from a local or remote database, or other information) or providing an option for a user entity to input commands (e.g., to control the operation of a scientific instrument such as the scientific instrument 1810 of FIG. 18, or to control the analysis of data generated by a scientific instrument), queries (e.g., to a local or remote database), or other information. In some embodiments, these interactions can be performed through a graphical user interface (GUI) that includes a visual display on a display device (e.g., the display device 410 discussed herein with reference to FIG. 4) that provides outputs to the user entity and/or prompts the user entity to provide inputs (e.g., via one or more input devices, such as a keyboard, mouse, trackpad, or touchscreen, included in the other I/O devices 412 discussed herein with reference to FIG. 4). The scientific instrument system 1800 disclosed herein can include any suitable GUIs for interaction with a user entity.

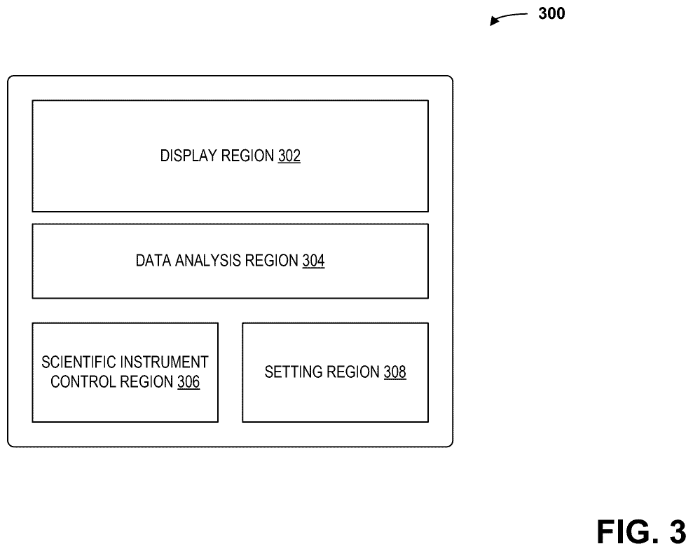

Turning next to FIG. 3, depicted is an example GUI 300 that can be used in the performance of some or all of the methods described herein, in accordance with various embodiments described herein. As noted above, the GUI 300 can be provided on a display device (e.g., the display device 410 discussed herein with reference to FIG. 4) of a computing device (e.g., the computing device 400 discussed herein with reference to FIG. 4) of a scientific instrument system (e.g., the scientific instrument system 1800 discussed herein with reference to FIG. 18), and a user entity can interact with the GUI 300 using any suitable input device (e.g., any of the input devices included in the other I/O devices 412 discussed herein with reference to FIG. 4) and input technique (e.g., movement of a cursor, motion capture, facial recognition, gesture detection, voice recognition, actuation of buttons, etc.).

The GUI 300 can include a data display region 302, a data analysis region 304, a scientific instrument control region 306, and a settings region 308. The particular number and arrangement of regions depicted in FIG. 3 is merely illustrative, and any number and arrangement of regions, including any desired features thereof, can be included in a GUI 300.

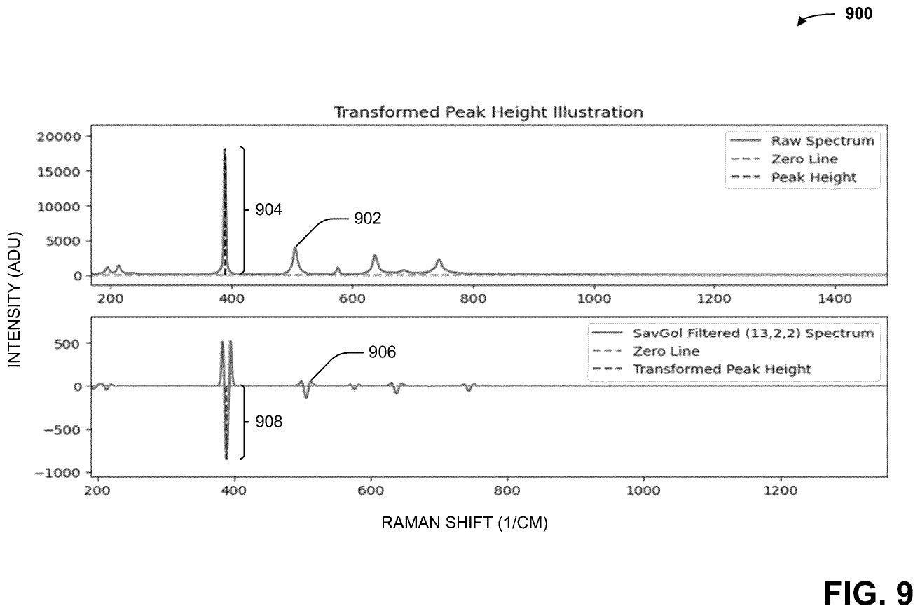

The data display region 302 can display data generated by a scientific instrument (e.g., the scientific instrument 1810 discussed herein with reference to FIG. 18). For example, the data display region 302 can display a spectrum or data representing such spectrum, such as illustrated at spectrum 902 of FIG. 9.

The data analysis region 304 can display the results of data analysis (e.g., the results of analyzing the data illustrated in the data display region 302 and/or other data). For example, the data analysis region 304 can display a target composition or identification. In one or more embodiments, the data display region 302 and the data analysis region 304 can be combined in the GUI 300 (e.g., to include data output from a scientific instrument, and some analysis of the data, in a common graph or region).

The scientific instrument control region 306 can include options that allow the user entity to control a scientific instrument (e.g., the scientific instrument 1810 discussed herein with reference to FIG. 18). For example, the scientific instrument control region 306 can include one or more controls for selecting and/or verifying selection of a known composition for use in identification of a sample composition.

The settings region 308 can include options that allow the user entity to control the features and functions of the GUI 300 (and/or other GUIs) and/or perform common computing operations with respect to the data display region 302 and data analysis region 304 (e.g., saving data on a storage device, such as the storage device 404 discussed herein with reference to FIG. 4, sending data to another user entity, labeling data, etc.). For example, the settings region 308 can include one or more options to alter color, fill or format of illustrations.

As noted above, the scientific instrument module 100 can be implemented by one or more computing devices. Accordingly, discussion next turns to FIG. 4, which illustrates a block diagram of a computing device 400 that can perform some or all of the scientific instrument methods disclosed herein, in accordance with various embodiments. In one or more embodiments, the scientific instrument module 100 can be implemented by a single computing device 400 or by multiple computing devices 400. Further, as discussed below, a computing device 400 (or multiple computing devices 400) that implements the scientific instrument module 100 can be part of one or more of the scientific instrument 1810, the user local computing device 1820, the service local computing device 1830, or the remote computing device 1840 of FIG. 18.

The computing device 400 of FIG. 4 is illustrated as having a number of components, but any one or more of these components can be omitted or duplicated, as suitable for the application and setting. As illustrated, these components can include one or more of a processor 402, storage device 404, interface device 406, battery/power circuitry 408, display device 410 and other input/output (I/O) devices 412, as will be described below.

In one or more embodiments, one or more of the components included in the computing device 400 can be attached to one or more motherboards and enclosed in a housing (e.g., including plastic, metal, and/or other materials). In one or more embodiments, some these components can be fabricated onto a single system-on-a-chip (SoC) (e.g., an SoC can include one or more processors 402 and one or more storage devices 404). Additionally, in one or more embodiments, the computing device 400 can omit one or more of the components illustrated in FIG. 4. In one or more embodiments, the computing device 400 can include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 400 can omit a display device 410, but can include display device interface circuitry (e.g., a connector and driver circuitry) to which a display device 410 can be coupled.

The computing device 400 can include the processor 402 (e.g., one or more processing devices). As used herein, the term “processing device” can refer to any device or portion of a device that processes electronic data from registers and/or memory to transform that electronic data into other electronic data that can be stored in registers and/or memory. The processor 402 can include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 400 can include a storage device 404 (e.g., one or more storage devices). The storage device 404 can include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In one or more embodiments, the storage device 404 can include memory that shares a die with a processor 402. In such an embodiment, the memory can be used as cache memory and can include embedded dynamic random access memory (eDRAM) or spin transfer torque magnetic random access memory (STT-MRAM), for example. In one or more embodiments, the storage device 404 can include non-transitory computer readable media having instructions thereon that, when executed by one or more processing devices (e.g., the processor 402), cause the computing device 400 to perform any appropriate ones of or portions of the methods disclosed herein.

The computing device 400 can include an interface device 406 (e.g., one or more interface devices 406). The interface device 406 can include one or more communication chips, connectors, and/or other hardware and software to govern communications between the computing device 400 and other computing devices. For example, the interface device 406 can include circuitry for managing wireless communications for the transfer of data to and from the computing device 400. The term “wireless” and its derivatives can be used to describe circuits, devices, systems, methods, techniques, communications channels, etc., that can communicate data through the use of modulated electromagnetic radiation through a nonsolid medium. The term does not imply that the associated devices do not contain any wires, although in one or more embodiments the associated devices might not contain any wires. Circuitry included in the interface device 406 for managing wireless communications can implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In one or more embodiments, circuitry included in the interface device 406 for managing wireless communications can operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In one or more embodiments, circuitry included in the interface device 406 for managing wireless communications can operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In one or more embodiments, circuitry included in the interface device 406 for managing wireless communications can operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In one or more embodiments, the interface device 406 can include one or more antennas (e.g., one or more antenna arrays) to receipt and/or transmission of wireless communications.

In one or more embodiments, the interface device 406 can include circuitry for managing wired communications, such as electrical, optical, or any other suitable communication protocols. For example, the interface device 406 can include circuitry to support communications in accordance with Ethernet technologies. In one or more embodiments, the interface device 406 can support both wireless and wired communication, and/or can support multiple wired communication protocols and/or multiple wireless communication protocols. For example, a first set of circuitry of the interface device 406 can be dedicated to shorter-range wireless communications such as Wi-Fi or Bluetooth, and a second set of circuitry of the interface device 406 can be dedicated to longer-range wireless communications such as global positioning system (GPS), EDGE, GPRS, CDMA, WiMAX, LTE, EV-DO, or others. In one or more embodiments, a first set of circuitry of the interface device 406 can be dedicated to wireless communications, and a second set of circuitry of the interface device 406 can be dedicated to wired communications.

The computing device 400 can include battery/power circuitry 408. The battery/power circuitry 408 can include one or more energy storage devices (e.g., batteries or capacitors) and/or circuitry for coupling components of the computing device 400 to an energy source separate from the computing device 400 (e.g., AC line power).

The computing device 400 can include a display device 410 (e.g., multiple display devices). The display device 410 can include any visual indicators, such as a heads-up display, a computer monitor, a projector, a touchscreen display, a liquid crystal display (LCD), a light-emitting diode display, or a flat panel display.

The computing device 400 can include other input/output (I/O) devices 412. The other I/O devices 412 can include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 400, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 400 can have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

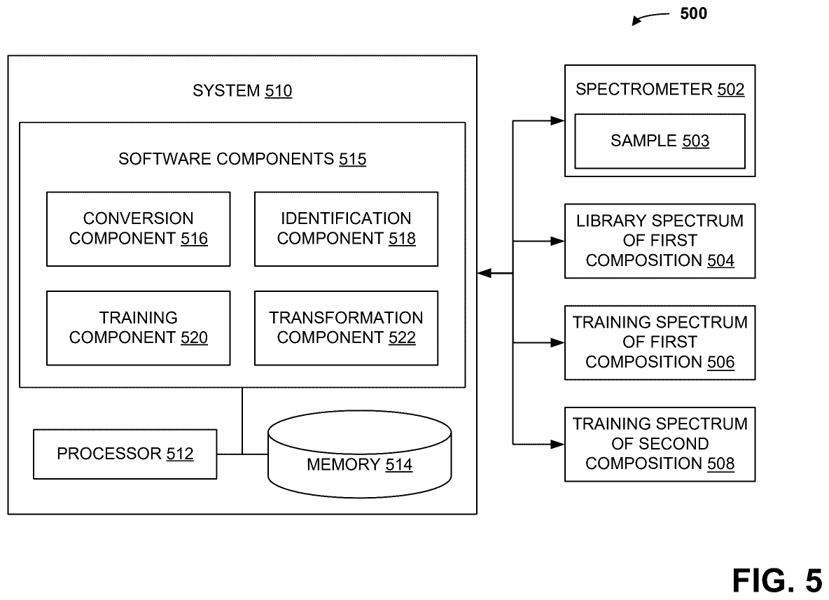

Referring next to FIG. 5, in one or more embodiments, the non-limiting system 500 illustrated at FIG. 5, and/or systems thereof, can further comprise one or more computer and/or computing-based elements described herein with reference to a computing environment, such as the computing environment 2000 illustrated at FIG. 20. In one or more described embodiments, computer and/or computing-based elements can be used in connection with implementing one or more of the systems, devices, components and/or computer-implemented operations shown and/or described in connection with FIG. 5 and/or with other figures described herein.

Turning first to FIG. 5, the figure illustrates a block diagram of an example, non-limiting system 500 that can comprise a system 510. The system 510 can facilitate a process to identify if a sample is a target composition based on one or more binary features of a spectrum of the sample. In one or more embodiments, system 510 can be at least partially comprised by the computing device 400.

In various embodiments, there can be a spectrometer 502. In various aspects, the spectrometer 502 can be constructed, composed, or otherwise made up of any suitable constituent hardware for generating, capturing, or otherwise measuring spectra of samples. As a non-limiting example, the spectrometer 502 can be made up of any suitable light source (e.g., globar light source, Nernst glower, tungsten-halogen lamp, deuterium lamp, Raman laser, any other suitable type of laser), any suitable adjustable or non-adjustable aperture (e.g., iris aperture that can be controllably opened or closed; fixed aperture), any suitable beamsplitter (e.g., cube beamsplitter, plate beamsplitter, pellicle beamsplitter, Glan-Taylor beamsplitter, dielectric beamsplitter), any suitable adjustable mirrors (e.g., motor-operated flat mirrors that can be controllably translated or tilted, motor-operated retroreflector mirrors that can be controllably translated or tilted, motor-operated spherical mirrors that can be controllably translated or tilted), and any suitable photodetectors (e.g., photodiodes, bolometers, CCDs). As a non-limiting example, the spectrometer 502 can be a Fourier Transform Infrared (FTIR). As another non-limiting example, the spectrometer 502 can be a Raman spectrometer, such as a Fourier Transform Raman (FT-Raman) spectrometer. In various aspects, the spectrometer 502 can employ any suitable techniques for generating, capturing, or otherwise measuring spectra of samples. As a non-limiting example, the spectrometer 502 can employ Surface-Enhanced Raman Spectroscopy (SERS) to enhance signal quality.

In various instances, the spectrometer 502 can be loaded with a sample 503. In various aspects, the sample 503 can be any sample of interest. In various embodiments, the spectrometer 502 (or a computerized workstation associated with the spectrometer 502) can scan sample 503, thereby yielding a spectrum (e.g., sample spectrum 702) of sample 503. In various cases, the arrangement or shapes of peaks shown in the spectrum can uniquely correspond to or otherwise be associated with the chemical composition of sample 503. In various cases, it can be desired to analyze the spectrum produced by the spectrometer 502 to identify the sample 503. As described herein, system 510 can facilitate such analysis and identification of sample 503.

In various aspects, the system 510 can comprise a processor 512 (e.g., computer processing unit, microprocessor) and a non-transitory computer-readable memory 514 that is operably or operatively or communicatively connected or coupled to the processor 512. The non-transitory computer-readable memory 514 can store computer-executable instructions which, upon execution by the processor 512, can cause the processor 512 or other components of the system 510 (e.g., conversion component 516, identification component 518, training component 520, transformation component 522) to perform one or more acts. In various embodiments, the non-transitory computer-readable memory 514 can store computer-executable components (e.g., conversion component 516, identification component 518, training component 520, transformation component 522), and the processor 512 can execute the computer-executable components.

In various embodiments, the system 510 can have or include a transformation component 522. In various aspects, the transformation component 522 can be electronically coupled or integrated to or with the spectrometer 502 via any suitable wired or wireless electronic connections. So, in various instances, the transformation component 522 can electronically access the spectrometer 502. That is, the transformation component 522 can electronically communicate or interface with the spectrometer 502, such that any other component of the system 510 can electronically interact with (e.g., transmit electronic instructions or commands to, receive electronic data from, manipulate) the spectrometer 502.

In various instances, the transformation component 522 can electronically access or receive a spectrum (e.g., sample spectrum 702) of sample 503 produced by spectrometer 502.

In various aspects, the transformation component 522 can, as described herein, apply a transformation to the spectrum of sample 503, yielding a transformed sample spectrum (e.g., transformed sample spectrum 804).

Additionally, the transformation component 522 can electronically access a library spectrum of the first target composition 504. In various embodiments, the transformation component 522 can apply the transformation to the library spectrum of the first target composition 504, yielding a transformed library spectrum of the first target composition (e.g., transformed library spectrum 806).

In particular, the transformation component 522 can apply an SG transformation to the spectrum of sample 503 and to the library spectrum of the first target composition 504. In various aspects, the SG transformation can cause the transformed spectra of the spectrum of sample 503 and the library spectrum of the first target composition 504 to have transformed peaks that correspond to peaks in the untransformed spectra.

In various embodiments, the system 510 can have or include a conversion component 516. In various aspects, the conversion component 516 can, as described herein, electronically generate sample ratios (e.g., sample ratios 1004) of transformed peaks in the transformed sample spectrum. Likewise, the conversion component 516 can electronically generate library ratios (e.g., library ratios 1006) of transformed peaks in the transformed library spectrum of the first target composition. Based on the sample ratios and the library ratios, the conversion component 516 can generate relative ratios (e.g., relative ratios 1002). That is, for any sample received, the conversion component 516 can generate relative ratios based on the transformed sample spectrum relative to the transformed library spectrum of the first target composition. More specifically, in various aspects, the conversion component 516 can generate a relative ratio for each transformed peak.

Thereafter, the conversion component 516 can generate one or more binary features (e.g., the set of binary features 1008) based on the relative ratios meeting (e.g., satisfying) corresponding thresholds. Specifically, the conversion component 516 can assign a value of 1 to a binary feature if the relative ratio corresponding to a transformed peak meets the corresponding threshold. Conversely, the conversion component 516 can assign a value of 0 to the binary feature if the relative ratio corresponding to the transformed peak does not meet the corresponding threshold.

In various embodiments, the system 510 can have or include an identification component 518. In various aspects, the identification component 518 can, as described herein, dynamically update a probability parameter associated with the first target composition (e.g., a probability that the sample contains the first target composition) based on the one or more binary features. In various aspects, the identification component can sum the one or more binary features to determine the probability parameter. Specifically, the probability parameter can have an initial probability (e.g., a prior probability) of 50%. In various instances, as the identification component 518 receives the one or more binary features and their value assignments, the identification component can dynamically update the probability parameter based on conditional probabilities that correspond to the first target composition.

Thus, the identification component 518 can identify or verify if the sample 503 contains the first target composition based on the probability parameter that results after updating based on the one or more binary features. More specifically, identification component can identify or verify if the sample contains the first target composition based on a sum of the one or more binary features. For example, the identification component 518 can identify or verify that the sample 503 contains the first target composition if the probability parameter is above 50%, and can identify or verify that the sample 503 does not contain the first target composition if the probability parameter is below 50%.

In order to achieve a more accurate differentiation power, the various embodiments here can first undergo a training phase. In various embodiments, the system 510 can have or include a training component 520. In various aspects, the training component 520 can, as described herein, facilitate such training phase.

In particular, the training component 520 can generate the thresholds and the conditional probabilities during the training phase. Thus, during application to identify or verify sample 503, the conversion component 516 can electronically access the thresholds to generate the one or more binary features, and the identification component 518 can electronically access the conditional probabilities to identify if the sample 503 contains the first target composition.

In various embodiments, the training component 520 can electronically access training spectrum of the first target composition 506 and training spectrum of the second target composition 508. In various aspects, the training component 520 can generate the thresholds using an entropy method on relative ratios determined for the training spectrum of the first target composition 506 and the training spectrum of the second target composition 508. More specifically, similarly to how the relative ratios are generated for the sample 503, the training component 520 can generate relative ratios for the training spectrum of the first target composition 506. Likewise, the training component 520 can generate relative ratios for the training spectrum of the second target composition 508.

To generate the relative ratios for the training spectrum of the second target composition 508, the training component 520 can electronically access or receive a library spectrum of the second target composition. Thereafter, the training component 520 can generate the library ratios for the library spectrum of the second target composition in a similar fashion as generating the library ratios for the library spectrum of the first target composition 504.

Accordingly, the training component 520 can employ the entropy method between the relative ratios for the training spectrum of the first target composition 506 and the relative ratios for the training spectrum of the second target composition 508.

The entropy method is a statistical approach used to measure the uncertainty or randomness in a dataset. In various embodiments, the entropy method can quantify the variability in the relative ratios to determine optimal threshold values for distinguishing between the first target composition and the second target composition. By analyzing the distribution of spectral information, the entropy method can enhance the separation power of classification, improving the accuracy of identifying whether the sample contains the first target composition. In other words, by employing the entropy method to generate the thresholds, the thresholds can enable a more accurate separation power in identifying if the sample contains the first target composition.

In various instances, the training component 520 can also generate thresholds and conditional probabilities that correspond to the second target composition. By doing so, the identification component 518 can instead use the thresholds and conditional probabilities that correspond to the second target composition to identify if the sample 503 contains the second target composition.

In various embodiments, the training component 520 can identify what set of peaks to analyze (e.g., to transform and convert to binary features) during the training phase. More specifically, the training component 520 can identify the set of peaks based on the library spectrum of the first target composition 504. Similarly, if identifying if the sample 503 contains the second target composition, the training component 520 can identify the set of peaks to analyze based on the library spectrum of the second target composition.

Additionally, since the training component 520 determines the library ratios for the first target composition and the second target composition in the training phase, the training component 520 can store the library ratios for subsequent access when identifying a sample. For example, to determine if a sample contains the first target composition, the conversion component 516 can access the library ratios corresponding to the first target composition to generate the relative ratios for the sample. In other instances, to determine if a sample contains the second target composition, the conversion component 516 can access the library ratios corresponding to the second target composition to generate the relative ratios for the sample.

Furthermore, during generation of the relative ratios of the sample 503, the conversion component 516 can instead electronically access the library ratios of the library spectrum of the first target composition 504 that were determined in the training phase. Thus, the conversion component 516 can reduce computational resources by refraining from recomputing the library ratios each time a sample is received to be identified.

Note that, although the various embodiments described herein primarily discuss differentiating between two target compositions, the various embodiments described herein can be extended to differentiate between two or more compositions. For example, during the training phase, the training component 520 can determine corresponding thresholds and conditional probabilities for each target composition. Further, the training component 520 can employ the entropy method on relative ratios generated for each target composition (e.g., using training spectra for each target composition) to generate the optimal thresholds for differentiating between the two or more target compositions.

Note that, in various instances, the conversion component 516, the identification component 518, the training component 520, and the transformation component 522 can collectively be considered as being one or more software components 315 of the system 510. In various aspects, it should be appreciated that the one or more software components 515 are described primarily herein as comprising three components (e.g., the conversion component 516, the identification component 518, the training component 520, and the transformation component 522) for ease of explanation and illustration. However, the one or more software components 315 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the conversion component 516, the identification component 518, the training component 520, and the transformation component 522). In other embodiments, the functionalities described herein of such three components can instead be distributed, separated, split, or fragmented in any suitable fashions, so as to be implemented in or by more than three components (e.g., two or more components can facilitate the functionalities that are performable by the conversion component 516; two or more components can facilitate the functionalities that are performable by the identification component 518; two or more components can facilitate the functionalities that are performable by the training component 520; two or more components can facilitate the functionalities that are performable by the transformation component 522).

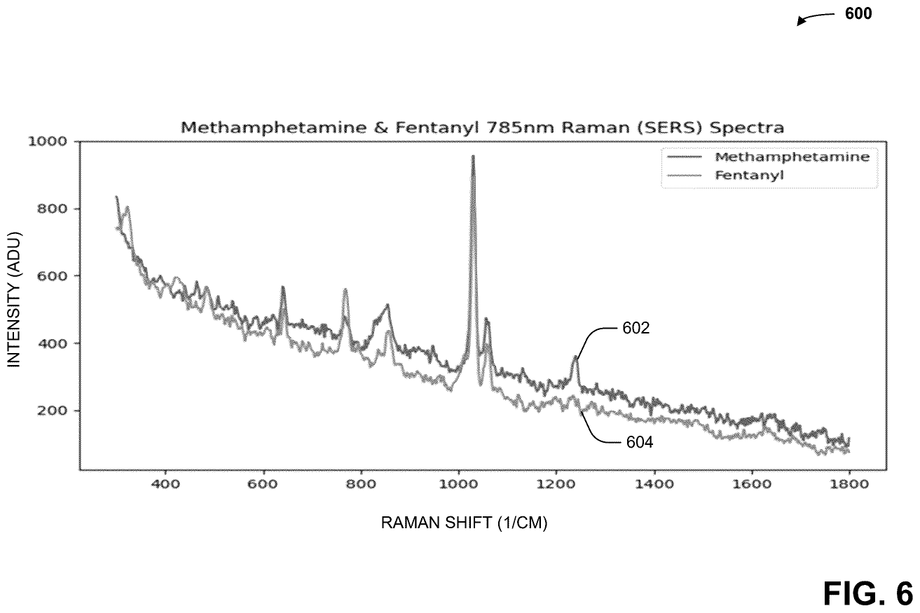

FIG. 6 illustrates an example, non-limiting graph 600 of spectra of two compositions with similar spectral features in accordance with one or more embodiments described herein.

In various instances, it can be desirable to identify if sample 503 is a first target composition or a second target composition. As a non-limiting example, it can be desirable to identify if sample 503 is methamphetamine or fentanyl. However, the first target composition and the second target composition can exhibit similar spectral features due to one or more structural similarities therebetween, with differentiating peaks often being very small and buried under noise, especially in SERS scans, and thus making differentiating between them difficult. That is, the first target composition and the second target composition can exhibit peaks at similar or closely located wavenumbers that are hidden by noise, which can lead to identification failures by existing algorithms. As a non-limiting example, as shown in FIG. 6, which depicts Raman spectra of methamphetamine and fentanyl, methamphetamine (represented by line 602) and fentanyl (represented by line 604) exhibit peaks at similar or closely located wavenumbers. For instance, methamphetamine and fentanyl both exhibit significant peaks at wavenumber shifts around 1002, 1029, 620, 830, 745, 464, and 1206, while smaller differentiating peaks disappear due to SERS noise, thus making identification of sample 503 as methamphetamine or fentanyl using existing methods unreliable and prone to misidentification of sample 503.

In some cases, upon closer examination of the spectra, the ratios of peak heights can provide characteristic features unique to each sample. However, these features do not always hold true, particularly when SERS is employed, or when dealing with lower concentrations or mixtures. In such cases, the characteristic features may no longer be reliable indicators to identify sample 503.

For instance, existing methods compare a sample with library spectra of target compositions and computes a p-value to identify the sample. In various cases, such existing methods can initially identify a methamphetamine scan as methamphetamine with a high p-value when compared to the methamphetamine library. However, when the same methamphetamine scan is compared to the fentanyl library, it also identifies it as fentanyl with a high p-value. That is, such existing methods can be prone to false positives or false negatives when identifying a sample.

Thus, when differentiating sample 503 between two target compositions that exhibit similar spectral features, such as methamphetamine and fentanyl, a methodology for more accurate and reliable differentiation between the two target compositions is desirable. Accordingly, the various embodiments discussed herewith can provide such methodology.

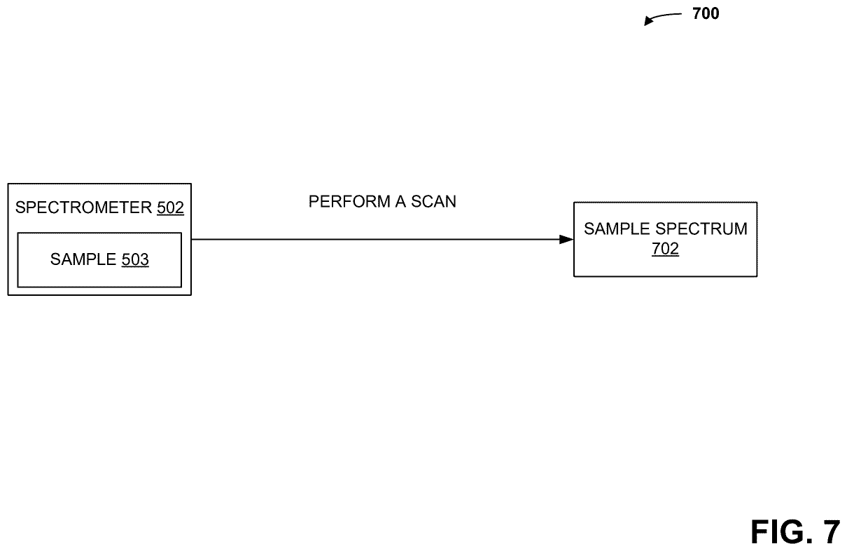

FIG. 7 illustrates an example, non-limiting block diagram 700 showing how a spectrometer can produce a spectrum of a sample in accordance with one or more embodiments described herein.

In various embodiments, the spectrometer 502 can be loaded with a sample 503. In various aspects, the sample 503 can be any suitable substance or composition. As a non-limiting example, the sample 503 can be any suitable type of gas or gaseous mixture, such as carbon monoxide, carbon dioxide, methane, water vapor, nitrogen oxide, sulfur dioxide, ammonia, hydrogen sulfide, or volatile organic compounds. As another non-limiting example, the sample 503 can be any suitable type of liquid solution or aqueous mixture, such as water, organic solvents, oils, beverages, or pharmaceutical agents. As even another non-limiting example, the sample 503 can be any suitable type of solid or alloy, such as thermoplastics, rubbers, silicates, carbonates, oxides, waxes, or food solids.

In any case, the transformation component 522 can electronically instruct, electronically command, or otherwise electronically cause the spectrometer 502 to scan the sample 503. In various instances, such scan can be performed using any suitable operational settings of the spectrometer 502. As a non-limiting example, if the aperture of the spectrometer 502 is adjustable, such scan can be performed using any suitable openness or closedness setting of the aperture. As another non-limiting example, such scan can be performed using any suitable physical position or orientation settings of the adjustable mirrors of the spectrometer 502. As yet another non-limiting example, such scan can be performed using any suitable power setting of the light source of the spectrometer 502. In any case, such scan can cause the spectrometer 502 to produce, generate, or otherwise output a sample spectrum 702.

In various aspects, the sample spectrum 702 can be considered as a graph, plot, or chart of intensity value exhibited by the sample 503 as a function of Raman shift (e.g., non-limiting graph 600). Note that, although various embodiments are described and illustrated herein as applying to Raman spectra, these are mere non-limiting examples. It should be understood or otherwise appreciated that various embodiments described herein can be applied to any other suitable types of spectra, such as transmittance spectra. In any case, it can be desirable to identify sample 503 based on the sample spectrum 702.

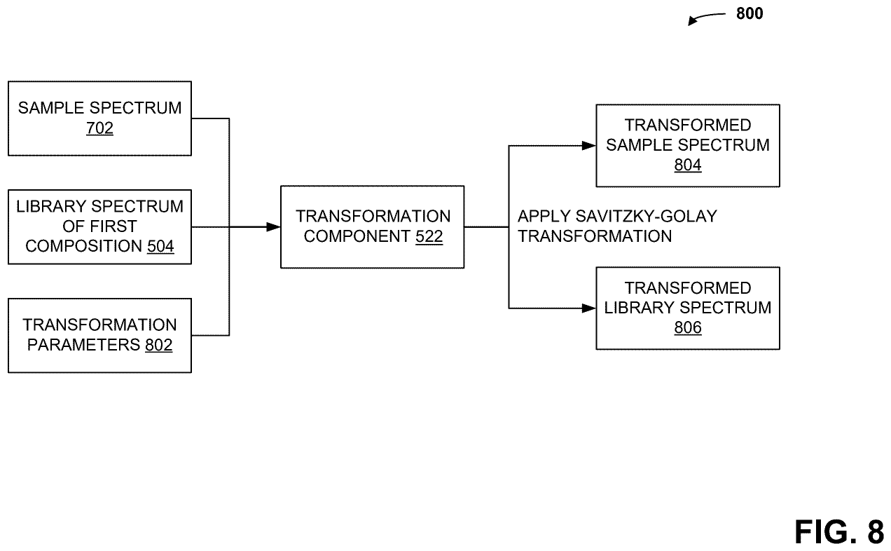

FIG. 8 illustrates an example, non-limiting block diagram 800 showing how a transformed sample spectrum can be obtained in accordance with one or more embodiments described herein.

In various embodiments, the transformation component 522 can electronically access the sample spectrum 702 and the library spectrum of the first target composition 504. In various aspects, the transformation component 522 can apply a transformation to the sample spectrum 702 using transformation parameters 802, thereby yielding transformed sample spectrum 804. Likewise, the transformation component 522 can apply the same transformation to the library spectrum of the first target composition 504 using transformation parameters 802, thereby yielding transformed library spectrum 806.

More specifically, the transformation component 522 can apply an SG transformation to the sample spectrum 702 and the library spectrum of the first target composition 504. In various aspects, the transformation parameters 802 can be any suitable parameters that cause the resulting transformed spectrum to exhibit peaks with reduced noise. In various instances, the transformation component 522 can determine the transformation parameters based on various factors, such as resolution, noise, frequencies, or characteristic peaks of the target compositions.

In particular, the transformation component 522 can apply an SG transformation with a defined window size, polynomial order, and derivative of even order to the sample spectrum 702 and the library spectrum of the first target composition 504. By applying an SG transformation with the defined window size, polynomial order, and even derivative to a spectrum, the resulting transformed spectrum exhibits valleys at wavenumbers where peaks in the untransformed spectra are with reduced noise. Thus, applying such SG transformation with such parameters can produce transformed spectra where valley depths are reliably representative of peak heights in the untransformed spectra. In various aspects, the valleys in the transformed spectra can be considered as transformed peaks. Accordingly, as used herein, the term “valley” is used interchangeably with “transformed peak”. Thus, the valley depths can be considered as and are referred to herein as transformed peak heights. In various aspects, each of the transformed peak heights can be defined by a minimum value within a 10-wavenumber window of the transformed peak, where the minimum values can represent the proportional heights of each transformed peak.

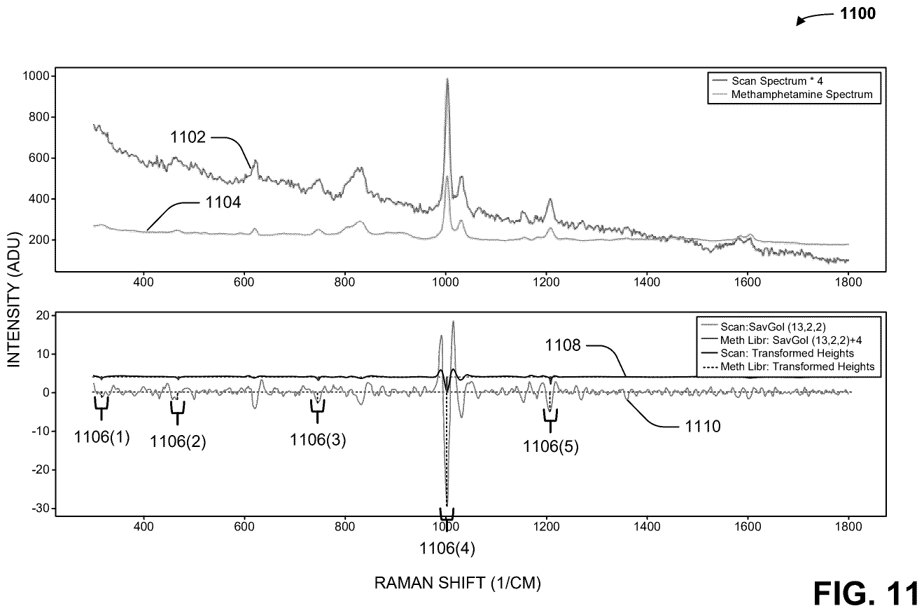

Accordingly, the transformed sample spectrum 804 can exhibit valleys at wavenumbers where the sample spectrum 702 exhibits peaks. Likewise, the transformed library spectrum 806 can exhibit valleys at wavenumbers where the library spectrum of the first target composition 504 exhibits peaks. Various non-limiting examples are described with respect to FIGS. 9 and 11.

FIG. 9 illustrates an example, non-limiting diagram 900 showing application of a Savitzky-Golay transformation in accordance with one or more embodiments described herein.

In various embodiments, as mentioned above, the transformation component 522 can apply an SG transformation to a spectrum 902 (e.g., to the sample spectrum 702, to the library spectrum of the first target composition 504). Applying the SG transformation to spectrum 902 can result in transformed spectrum 906 where valleys in transformed spectrum 906 are representative of peaks in spectrum 902. In certain non-limiting examples wherein a sample of interest may comprise methamphetamine and/or fentanyl, the transformation component 522 may apply an SG transformation with a window size of 13, a polynomial order of 2, and a second derivative to the sample spectrum 902.

For instance, spectrum 902 can exhibit a peak at wavenumber 395 with a peak height 904. Then, by applying the SG transformation to spectrum 902, the transformed spectrum 906 that results from applying the SG transformation can exhibit a valley at wavenumber 395 with a valley depth of 908. In various instances, the valley depth of 908 can be a reliable representation of the peak height 904 with reduced noise.

Similarly, as shown in FIG. 9, spectrum 902 exhibits peaks at around wavenumbers 300 and 500. Accordingly, applying the SG transformation produces valleys at around wavenumbers 300 and 500 in the transformed spectrum 906. That is, for a set of peaks areas in spectrum 902 (e.g., the sample spectrum 702, the library spectrum of the first target composition 504), the transformation component 522 can apply an SG transformation to produce a set of valleys at wavenumbers close to or near the set of peaks.

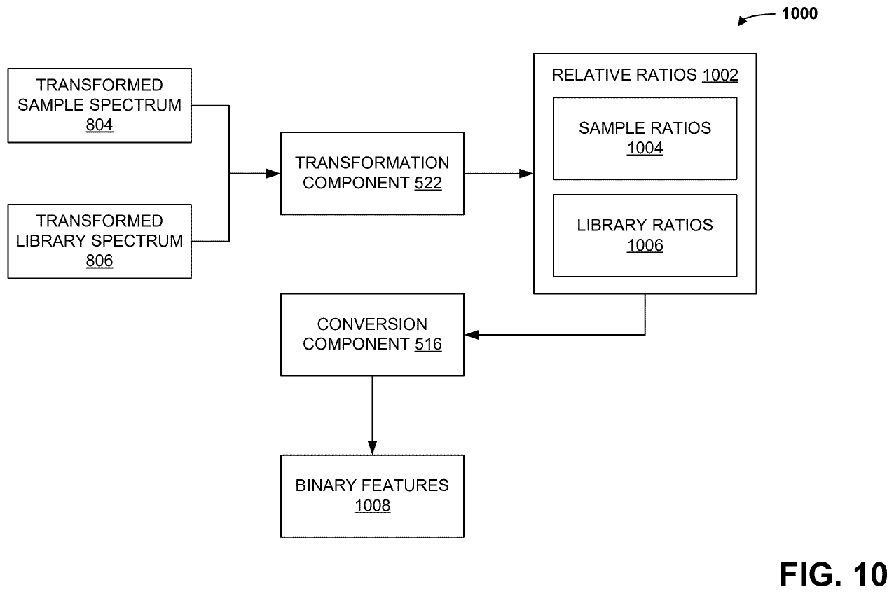

FIG. 10 illustrates an example, non-limiting block diagram 1000 showing how binary features can be generated in accordance with one or more embodiments described herein.

In various embodiments, the transformation component 522 can generate, based on the transformed sample spectrum 804 and the transformed library spectrum 806, relative ratios 1002.

To generate the relative ratios 1002, the transformation component 522 can determine sample ratios 1004 (e.g., Ratioₛₘₚₗ) based on the transformed peaks of the transformed sample spectrum 804. More specifically, the transformation component 522 can determine a sample ratio for each transformed peak, where the sample ratio is a ratio of the transformed peak (e.g., Peak Heightsₛₘₚₗ) relative to a base peak. In various aspects, the base peak can be a highest transformed peak (e.g., Heighest Peak Heightₛₘₚₗ) in the transformed sample spectrum 804. In various aspects, the transformation component 522 can determine the sample ratio for the transformed peak using transformed peak heights of the transformed peaks in transformed sample spectrum 804. The sample ratios 1004 can be determined with the following equation:

$${Ratio}_{smpl} = \frac{Peak {Heights}_{smpl}}{Heighest Peak {Height}_{smpl}}$$

Since the sample ratio for the transformed peak with the highest transformed peak height (e.g., the base peak) in the transformed sample spectrum 804 will always be 1 (e.g., Peak Heightsₛₐₘₚₗₑ=Heighest Peak Heightₛₐₘₚₗₑ), such sample ratio for the highest transformed peak can be discarded, omitted, or otherwise disregarded.

In various aspects, by creating the sample ratios 1004, the conversion component 516 effectively normalizes the transformed peak. In other words, the conversion component 516 can normalize, based on transformed peak heights, the transformed peaks by dividing each transformed peak height by the highest transformed peak height in the transformed sample spectrum 804.

To generate the relative ratios 1002, the transformation component 522 can further determine library ratios 1006 (e.g., Ratio_{lbr}) based on the transformed peaks of the transformed library spectrum 806. More specifically, the transformation component 522 can determine a library ratio for each transformed peak, where the library ratio is a ratio of the transformed peak (e.g., Peak Heights_{lbr}) relative to a base peak. In various aspects, the base peak can be a highest transformed peak (e.g., Heighest Peak Height_{lbr}) in the transformed library spectrum 806. In various aspects, the transformation component 522 can determine the library ratio for the transformed peak using transformed peak heights of the transformed peaks in transformed library spectrum 806. The library ratios 1006 can be determined with the following equation:

$${Ratio}_{lbr} = \frac{Peak {Heights}_{lbr}}{Heighest Peak {Height}_{lbr}}$$

Since the library ratio for the transformed peak with the highest transformed peak height (e.g., the base peak) in the transformed library spectrum 806 will always be 1 (e.g., Peak Heightsₛₘₚₗ=Heighest Peak Heightₛₘₚₗ), such library ratio for the highest transformed peak can be discarded, omitted, or otherwise disregarded.

In various aspects, by creating the library ratios 1006, the conversion component 516 effectively normalizes the transformed peak heights. In other words, the conversion component 516 can normalize the transformed peak heights by dividing each by the highest transformed peak height in the transformed library spectrum 806.

Thereafter, in various embodiments, the transformation component 522 can generate relative ratios 1002 with the following equation:

$${Ratio}_{rltv} = \frac{{Ratio}_{smpl} - {Ratio}_{lbr}}{{Ratio}_{lbr}}$$

In various aspects, by subtracting the library ratios 1006 from the sample ratios 1004 and dividing by the library ratios 1006, the resulting value in theory should be close to 0 when the library spectrum of the first target composition 504 and the sample spectrum 702 correspond to the same composition. Conversely, the resulting value in theory should be significantly different from 0 when they differ. This comparison enables assessment of the similarity or dissimilarity between the library spectrum of the first target composition 504 and the sample spectrum 702.

In various embodiments, the conversion component 516 can generate a set of binary features 1008 based on the relative ratios 1002. More specifically, the conversion component 516 can generate the set of binary features 1008 based on whether the relative ratios 1002 meet respective thresholds. In various aspects, the conversion component 516 can assign binary values to the set of binary features 1008 using the following equation, where f denotes a binary feature:

$$f = 1 if ratio meets threshold , else 0$$

That is, the conversion component 516 can generate a binary feature for each relative ratio, where the conversion component 516 assigns the binary feature a value of 0 if the relative ratio does not meet a respective threshold. Conversely, the conversion component 516 can assign the binary feature a value of 1 if the relative ratio does meet the respective threshold. Thus, the set of binary features 1008 will comprise n−1 binary features (e.g., one less than the number of transformed peaks) since the relative ratio for the highest transformed peak is disregarded. If all of the set of binary features 1008 are 1, it strongly suggests that the sample 503 is the first target composition. Conversely, if all of the set of binary features 1008 are 0, it strongly suggests that the sample 503 is not the first target composition.

Thereafter, based on the value assignments of the set of binary features 1008 (e.g., the sum of the set of binary features), the identification component 518 can dynamically update the probability parameter associated with the first target composition based on conditional probabilities that correspond to the first target composition.

As a non-limiting example, consider 4 binary features fₓ₁, fₓ₂, fₓ₃, and fₓ₄. Based on the thresholds and the sample spectrum 702, the conversion component 516 can assign a value of 0 or 1 to each of the 4 binary features. Thereafter, based on the value assignments of the set of binary features 1008, the identification component 518 can dynamically update the probability parameter associated with the first target composition using the conditional probabilities. For instance, P(S=x|sum(fₓ₁, fₓ₂, fₓ₃, fₓ₄)=4) represents the probability of being the first target composition (denoted by x) when all the set of binary features 1008 for the first target composition are true (e.g., meet the threshold). As another example, (S=x|sum(fₓ₁, fₓ₂, fₓ₃, fₓ₄)=2, fₓ₄=1) represents the probability when half of the binary features are true, where among the true binary features, the fourth binary feature is true.

In various embodiments, each of the set of binary features 1008 can have different impact strengths on the probability parameter. In other words, the training component 520 can prioritize the conditional probabilities, where each of the set of binary features 1008 can impact the probability parameter associated with the first target composition differently. In the non-limiting example of differentiating between methamphetamine and fentanyl, the training component 520 can determine the following probabilities that the sample 503 is the first target composition (e.g., methamphetamine) based on the prioritized conditional probabilities, where m denotes methamphetamine:

$$P ( S = m \vert sum ( {f}_{m 1} , {f}_{m 2} , {f}_{m 3} , {f}_{m 4} ) = 4 ) = 78 / 80$$

$$P ( S = m \vert sum ( {f}_{m 1} , {f}_{m 2} , {f}_{m 3} , {f}_{m 4} ) = 3 , {f}_{m 4} = 1 ) = 75 / 80$$

$$P ( S = m \vert sum ( {f}_{m 1} , {f}_{m 2} , {f}_{m 3} , {f}_{m 4} ) = 2 , {f}_{m 4} = 1 ) = 72 / 80$$

$$P ( S = m \vert sum ( {f}_{m 1} , {f}_{m 2} , {f}_{m 3} , {f}_{m 4} ) = 3 ) = 70 / 80$$

$$P ( S = m \vert sum ( {f}_{m 1} , {f}_{m 2} , {f}_{m 3} , {f}_{m 4} ) = 2 , {f}_{m 1} = 0 ) = 65 / 80$$

$$P ( S = m \vert sum ( {f}_{m 1} , {f}_{m 2} , {f}_{m 3} , {f}_{m 4} ) = 2 ) = 28 / 80$$

$$P ( S = m \vert sum ( {f}_{m 1} , {f}_{m 2} , {f}_{m 3} , {f}_{m 4} ) = 1 , {f}_{m 4} = 1 ) = 25 / 80$$

$$P ( S = m \vert sum ( {f}_{m 1} , {f}_{m 2} , {f}_{m 3} , {f}_{m 2} ) = 1 , {f}_{m 3} = 1 ) = 20 / 80$$

$$P ( S = m \vert sum ( {f}_{m 1} , {f}_{m 2} , {f}_{m 3} , {f}_{m 4} ) = 1 , {f}_{m 2} = 1 ) = 15 / 80$$

$$P ( S = m \vert sum ( {f}_{m 1} , {f}_{m 2} , {f}_{m 3} , {f}_{m 4} ) = 1 , {f}_{m 1} = 1 ) = 10 / 80$$

In various embodiments, the identification component 518 can assign a prior probability to methamphetamine, such as P(S=m)=40/80. This means that the initial probability that the sample 503 contains methamphetamine, before the set of binary features 1008 are considered is 50%. Thereafter, as the identification component 518 receives the set of binary features 1008 of sample 503, the identification component 518 can dynamically update the probability parameter associated with methamphetamine based on the conditional probabilities.

Conversely, in other instances, it can be desired to know if the sample 503 contains fentanyl (e.g., a second target composition). To determine if the sample 503 contains fentanyl, the training component 520 can determine thresholds and conditional probabilities that correspond to fentanyl.

In the non-limiting example of differentiating between methamphetamine and fentanyl, the training component 520 can determine the following probabilities that the sample 503 is the second target composition (e.g., fentanyl) based on the prioritized conditional probabilities, where f denotes fentanyl:

$$P ( S = f \vert sum ( {f}_{f 1} , {f}_{f 2} , {f}_{f 3} , {f}_{f 4} ) = 4 ) = 78 / 80$$

$$P ( S = f \vert sum ( {f}_{f 1} , {f}_{f 2} , {f}_{f 3} , {f}_{f 4} ) = 3 , {f}_{4 f} = 1 ) = 75 / 80$$

$$P ( S = f \vert sum ( {f}_{f 1} , {f}_{f 2} , {f}_{f 3} , {f}_{f 4} ) = 2 , {f}_{4 f} = 1 ) = 72 / 80$$

$$P ( S = f \vert sum ( {f}_{f 1} , {f}_{f 2} , {f}_{f 3} , {f}_{f 4} ) = 3 ) = 70 / 80$$

$$P ( S = f \vert sum ( {f}_{f 1} , {f}_{f 2} , {f}_{f 3} , {f}_{f 4} ) = 2 , {f}_{f 1} = 0 ) = 65 / 80$$

$$P ( S = f \vert sum ( {f}_{f 1} , {f}_{f 2} , {f}_{f 3} , {f}_{f 4} ) = 2 ) = 28 / 80$$

$$P ( S = f \vert sum ( {f}_{f 1} , {f}_{f 2} , {f}_{f 3} , {f}_{f 4} ) = 1 , {f}_{f 4} = 1 ) = 25 / 80$$

$$P ( S = f \vert sum ( {f}_{f 1} , {f}_{f 2} , {f}_{f 3} , {f}_{f 4} ) = 1 , {f}_{f 3} = 1 ) = 20 / 80$$

$$P ( S = f \vert sum ( {f}_{f 1} , {f}_{f 2} , {f}_{f 3} , {f}_{f 4} ) = 1 , {f}_{f 2} = 1 ) = 15 / 80$$

$$P ( S = f \vert sum ( {f}_{f 1} , {f}_{f 2} , {f}_{f 3} , {f}_{f 4} ) = 1 , {f}_{f 1} = 1 ) = 10 / 80$$

In various embodiments, the identification component 518 can assign a prior probability to fentanyl, such as P(S=f)=40/80. This means that the initial probability that the sample 503 contains fentanyl, before the set of binary features 1008 are considered is 50%. Thereafter, as the identification component 518 receives the set of binary features 1008 of sample 503, the identification component 518 can dynamically update the probability parameter associated with fentanyl based on the conditional probabilities.

In various embodiments, the training component 520 can prioritize the conditional probabilities. More specifically, the training component 520 can assign different weights to the conditional probabilities based on how strong an indicator a binary feature is. For example, if the second binary feature f_{f2} is a better indicator that a sample is fentanyl than the third binary feature f_{f3}, then the training component 520 can assign a higher weight to the second binary feature f_{f2}. Thus, if only the second binary feature f_{f2} is true, the probability parameter associated with fentanyl when only the second binary feature f_{f2} is true will be greater than the probability parameter when only the third binary feature f_{f3} is true (e.g., P(S=f|sum(f_{f1}, f_{f2}, f_{f3}, f_{f4})=1, f_{f2}=1)>P(S=f|sum(f_{f1}, f_{f2}, f_{f3}, f_{f4})=1, f_{f3}=1)).

In various aspects, the training component 122 can determine the conditional probabilities during a training phase. Following the training phase, the identification component 518 can electronically access the conditional probabilities during application. That is, the identification component 518 can electronically access the conditional probabilities to determine if the sample 503 contains the first target composition.

In various embodiments, based on the conditional probabilities, the identification component 518 can identify or verify that the sample 503 contains the first target composition. More specifically, if the probability parameter that results is above 0.5, then the identification component 518 can identify that the sample 503 does contain the first target composition. Conversely, if the probability parameter that results is below 0.5, then the identification component 518 can identify that the sample 503 does not contain the first target composition. For example, usign the conditional probabilities determined for methamphetamine, if only the fourth binary feature is true (e.g., f_{f4}=1) resulting in a probability parameter of 28/80, then the identification component 518 can identify or verify that the sample 503 does not contain methamphetamine. As another example, if three binary features are true, including the fourth binary feature, resulting in a probability parameter of 75/80, then the identification component 518 can identify or verify that the sample 503 does contain methamphetamine.

FIG. 11 illustrates another example, non-limiting diagram 1100 showing application of a Savitzky-Golay transformation in accordance with one or more embodiments described herein.

Graph 1120 illustrates a non-limiting example sample spectrum 1102 (referred to herein as “sample spectrum 1102”) of sample 503. Graph 1120 further illustrates a non-limiting library spectrum 1104 of a first target composition. In the non-limiting example of FIG. 11, the first target composition is methamphetamine, where the non-limiting library spectrum 1104 is referred to herein as “methamphetamine library 1104). The methamphetamine library 1104 can be a library spectrum of methamphetamine (e.g., a high-quality spectrum created beforehand using a good quality Raman system). In other words, graph 1120 illustrates sample spectrum 1102 and methamphetamine library 1104.

In various embodiments, the transformation component 522 can apply an SG transformation to the sample spectrum 1102 and the methamphetamine library 1104. In particular, the transformation component 522 applies an SG transformation with a window size of 13, a polynomial order of 3, and a second derivative, producing transformed sample spectrum 1110 and transformed methamphetamine library 1108. In various aspects, the SG transformation creates a set of valleys 1106 (e.g., a set of transformed peaks 1106) that are representative of peaks in the sample spectrum 1102 and methamphetamine library 1104. In various aspects, each of the transformed peaks 1106 in the transformed sample spectrum 1110 can have a respective transformed peak height (e.g., a respective valley depth). Similarly, each of the transformed peaks 1106 in the transformed methamphetamine library 1108 can have a respective transformed peak height.

In various embodiments, the set of transformed peaks 1106 can comprise n transformed peaks for any suitable positive integer n>2: a transformed peak 1106(1) to a transformed peak 1106(n).

In various embodiments, the transformation component 522 can determine sample ratios 1004 based on the transformed peak heights of the transformed sample spectrum 1110. Specifically, the transformation component 522 can create a sample ratio for each of the transformed peaks, where the sample ratio is a ratio of the transformed peak height relative to a highest transformed peak height in the transformed sample spectrum 1110. For example, a sample ratio for transformed peak 1106(1) in transformed sample spectrum 1110 can be defined by a ratio of the transformed peak height of transformed peak 1106(1) to the transformed peak of transformed peak 1106(4). Since the sample ratio for the transformed peak with the highest transformed peak height in the transformed sample spectrum 1110 will always be 1, such transformed peak (or the respective sample ratio) can be discarded, omitted, or otherwise disregarded. In other words, the base peak can be disregarded when determining the sample ratios (e.g., does not have a sample ratio associated with the base peak).

Likewise, the transformation component 522 can determine library ratios 1006 based on the transformed peak heights of the transformed methamphetamine library 1108. Specifically, the transformation component 522 can create a library ratio for each of the transformed peaks, where the library ratio is a ratio of the transformed peak height relative to a highest transformed peak height in the transformed methamphetamine library 1108. For example, a library ratio for transformed peak 1106(1) in transformed methamphetamine library 1108 can be defined by a ratio of the transformed peak height of transformed peak 1106(1) to the transformed peak of transformed peak 1106(4). Since the library ratio for the transformed peak with the highest transformed peak height in the transformed methamphetamine library 1108 will always be 1, such transformed peak (or the respective sample ratio) can be discarded, omitted, or otherwise disregarded. In other words, the base peak can be disregarded when determining the library ratios (e.g., does not have a library ratio associated with the base peak).

In various embodiments, the transformation component 522 can generate relative ratios 1002 based on the sample ratios 1004 and library ratios 1006. Thereafter, the conversion component 516 can generate the set of binary features 1008 based on the relative ratios 1002 meeting thresholds, from which the conversion component 516 can leverage to identify if the sample 503 having sample spectrum 1102 contains methamphetamine.

As a non-limiting example, consider the set of transformed peaks 1106. In various embodiments, the conversion component 516 can identify peaks in the library spectrum of the first target composition 504 at wavenumbers 315.174, 466.866, 745.954, 1002.03, and 1207.23, with 1002.03 being the highest peak. Using the transformed peak heights in the transformed sample spectrum 1110 and the transformed methamphetamine library 1108 results in the following relative ratios 1002 for each identified peak, where the relative ratio for the highest peak is disregarded:
315.174: −0.0182
466.866: 0.4757
745.954: 0.1469
1207.23: −0.0138

Thereafter, the conversion component 516 can generate the set of binary features 1008 based on the relative ratios 1002 meeting the thresholds that were determined in the training phase. The set of binary features 1008 that results are the following, where the first value represents the threshold, and the second value represents the binary value assignment to the binary feature:
315.174: (0.16,1), 466.866: (0.48,1), 745.954: (1.36,1), 1207.23: (−0.35,1)

$${f}_{m 1} = 1 : - 0.0182 \leq 0.16$$

$${f}_{m 2} = 1 : 0.4757 \leq 0.48$$

$${f}_{m 3} = 1 : 0.1469 \leq 1.36$$

$${f}_{m 4} = 1 : - 0.0138 \leq - 0.35$$

Since all the relative ratios meet their respective thresholds, all the all binary features have a value of 1. Therefore, the identification component 518 can update the probability parameter associated with methamphetamine based on these binary features (e.g., and based on the priority of the binary features). Using the conditional probabilities discussed with respect to the non-limiting example of FIG. 9, the identification component 518 can determine the probability parameter associated with methamphetamine to be the following:

$$P ( S = m \vert sum ( {f}_{m 1} , {f}_{m 2} , {f}_{m 3} , {f}_{m 4} ) = 4 ) = 78 / 80$$

Based on the probability parameter of 78/80, the identification component 518 can identify that the sample 503 contains methamphetamine with high confidence.

Note that this is a mere non-limiting example, and that the various embodiments described herein can be applied to any desired substance or composition (e.g., to identify or verify if the sample 503 contains any desired substance or composition).

In various aspects, the conversion component 516 can generate the set of binary features 1008 for each new sample. This way, the various embodiments described herein only require one library of a target composition to determine if the sample contains the target composition as opposed to another spectrally similar composition. In this sense, the various embodiments described herein act as a unary differentiator rather than a binary classifier, eliminating the need for multiple libraries of other target compositions during application (e.g., in the field when identifying or verifying a sample). This can be achieved by first determining the thresholds of the set of binary features 1008 based on the libraries of other target compositions during a training phase. Additionally, this enables the various embodiments described herein to identify a particular composition within a mixture. In other words, the various embodiments described herein can identify if particular compositions are present when the sample 503 is a mixture.

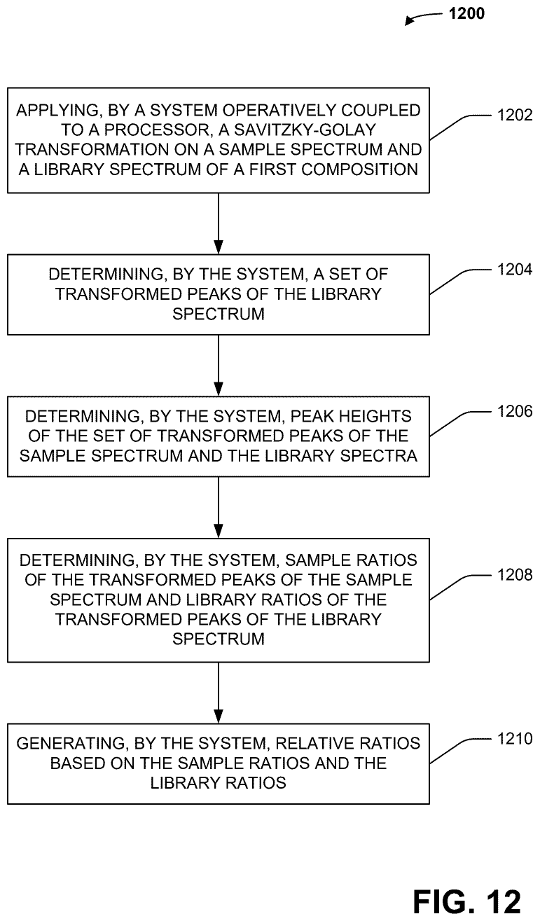

FIG. 12 illustrates a flow diagram of example, non-limiting method 1200 that can facilitate unary differentiation of compositions in accordance with one or more embodiments described herein.

At 1202, non-limiting method 1200 can comprise applying (e.g., by transformation component 522), by a system operatively coupled to a processor, a Savitzky-Golay transformation on a sample spectrum and a library spectrum of a first composition.

At 1204, non-limiting method 1200 can comprise determining (e.g., by conversion component 516), by the system, a set of transformed peaks of the library spectrum.

At 1206, non-limiting method 1200 can comprise determining (e.g., by conversion component 516), by the system, peak heights of the set of transformed peaks of the sample spectrum and the library spectrum.

At 1208, non-limiting method 1200 can comprise determining (e.g., by conversion component 516), by the system, sample ratios of transformed peaks of the sample spectrum and library ratios of transformed peaks of the library spectrum.

At 1210, non-limiting method 1200 can comprise generating (e.g., by conversion component 516), by the system, relative ratios based on the sample ratios and the library ratios.

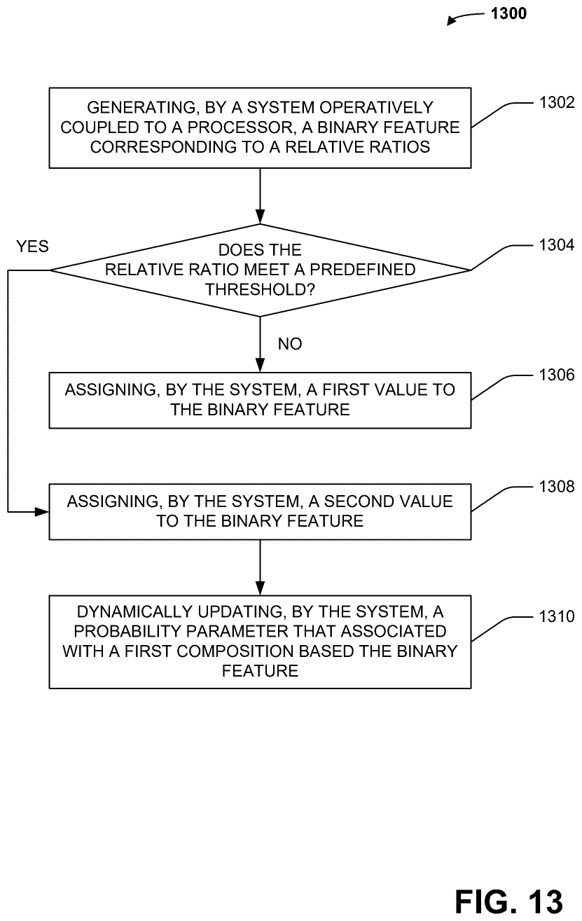

FIG. 13 illustrates a flow diagram of example, non-limiting method 1300 that can facilitate unary differentiation of compositions in accordance with one or more embodiments described herein.

At 1302, non-limiting method 1300 can comprise generating (e.g., by conversion component 516), by a system operatively coupled to a processor, a binary feature corresponding to a relative ratio. For instance, the conversion component 516 can determine, based on peak height, a relative ratio for a transformed peak. Thereafter, the conversion component 516 can generate a binary feature that corresponds to the transformed peak and the relative ratio.

At 1304, non-limiting method 1300 can comprise determining (e.g., by identification component 518), by the system, whether the relative ratio meets a predefined threshold. In various aspects, the predefined thresholds can be determined during the training phase based on training spectra.

If not, then at 1306, non-limiting method 1300 can comprise assigning (e.g., by identification component 518), by the system, a first value to the binary feature.

If yes, then at 1308, non-limiting method 1300 can comprise assigning (e.g., by identification component 518), by the system, a second value to the binary feature.

For instance, the identification component 518 can assign a value of 0 to the binary feature if it does not meet the threshold, and a value of 1 if the binary feature does meet the threshold.

At 1310, non-limiting method 1300 can comprise dynamically updating (e.g., by identification component 518), by the system, a probability parameter associated with a first composition based on the binary feature.

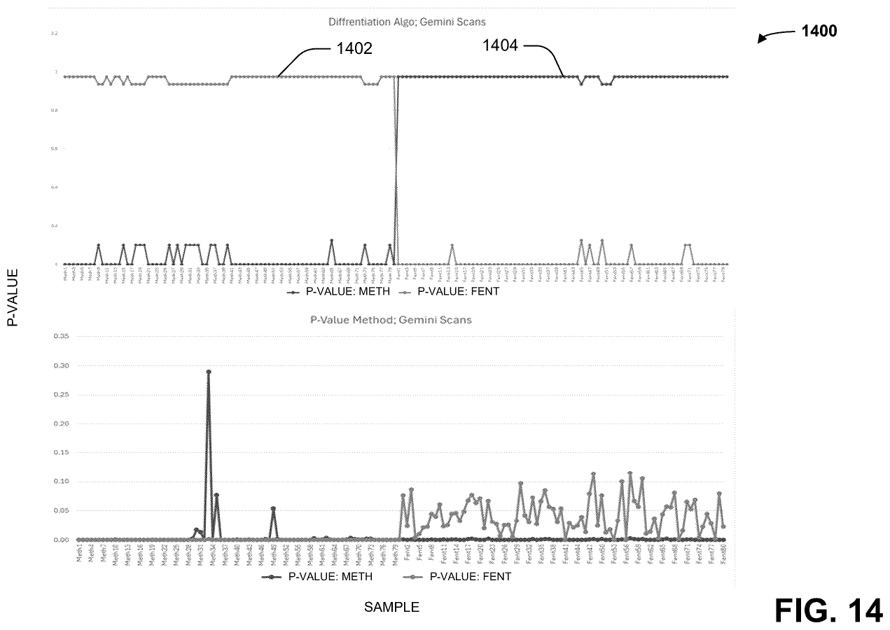

FIGS. 14-16 illustrate example, non-limiting experimental results in accordance with one or more embodiments described herein. Specifically, FIGS. 14-16 illustrate example, non-limiting experimental results in differentiating samples between methamphetamine and fentanyl. Following a training phase, the various embodiments described herein and a state-of-the-art existing method were applied to a total of 275 SERS2 samples, including 160 samples from a first device (80 methamphetamine samples and 80 fentanyl samples), 62 samples from a second device (12 methamphetamine samples and 50 fentanyl samples), and 53 samples from a third device (3 methamphetamine samples and 50 fentanyl samples).

First, consider FIG. 14. FIG. 14 depicts a graph 1400 of experimental results using the various embodiments described herein, a graph 1410 of experimental results using the state-of-the-art existing method on the 160 samples from the first device. In graph 1400 and graph 1410, the x-axis represents the 160 samples (e.g., 80 methamphetamine samples and 80 fentanyl samples) and the y-axis represents the p-value (e.g., the probability that the sample is methamphetamine or fentanyl).

The various embodiments described herein were applied to the 160 samples twice, identifying if the sample is methamphetamine one time (represented by line 1402), and identifying if the sample is fentanyl a second time (represented by line 1404). As can be seen, the graph 1400 demonstrates high separation margins with high confidence in the identification of the 160 samples. In other words, various embodiments described herein successfully identified all samples from the first device with a high separation margin. Conversely, in graph 1410, the p-values show limited differentiation and often overlap, resulting in a high number of false positives or true negatives, particularly under the 0.05 threshold. This leads to inconclusive inferences. In comparison to the state-of-the-art existing method, the various embodiments described herein demonstrate significantly better performance in differentiating spectrally similar compositions to identify the samples.

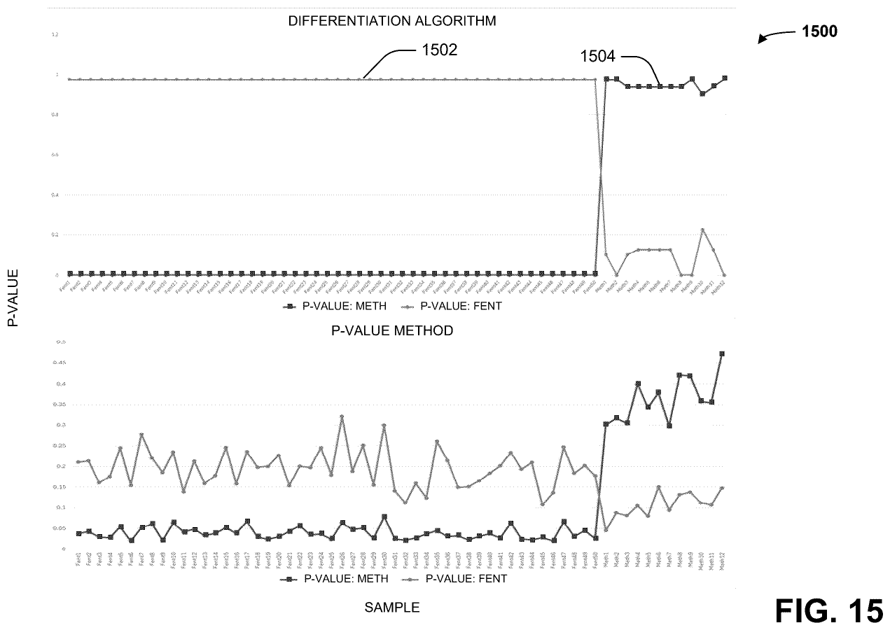

Now, consider FIG. 15. FIG. 15 depicts a graph 1500 of experimental results using the various embodiments described herein, a graph 1510 of experimental results using the state-of-the-art existing method on the 160 samples from the first device. In graph 1500 and graph 1510, the x-axis represents the 62 samples from the second device (e.g., 12 methamphetamine samples and 50 fentanyl samples) and the y-axis represents the p-value (e.g., the probability that the sample is methamphetamine or fentanyl).

The various embodiments described herein were applied to the 60 samples twice, identifying if the sample is methamphetamine one time (represented by line 1504), and identifying if the sample is fentanyl a second time (represented by line 1502). As can be seen, the graph 1500 demonstrates high separation margins with high confidence in the identification of the 160 samples. In other words, various embodiments described herein successfully identified all samples from the second device with a high separation margin. Conversely, in graph 1510, the p-values show limited differentiation with low confidence in identification. Due to the higher throughput of the second device, the spectra samples are of higher quality. Consequently, the p-values are higher. However, the p-values of unintended materials are also high, indicating a tendency to produce false positive results. Specifically, the methamphetamine samples generate high p-values when identifying for fentanyl (e.g., testing with the fentanyl library), even if they produce high p-values when identifying for methamphetamine (e.g., testing with the fentanyl library). In comparison to the state-of-the-art existing method, the various embodiments described herein demonstrate significantly better performance in differentiating spectrally similar compositions to identify the samples.

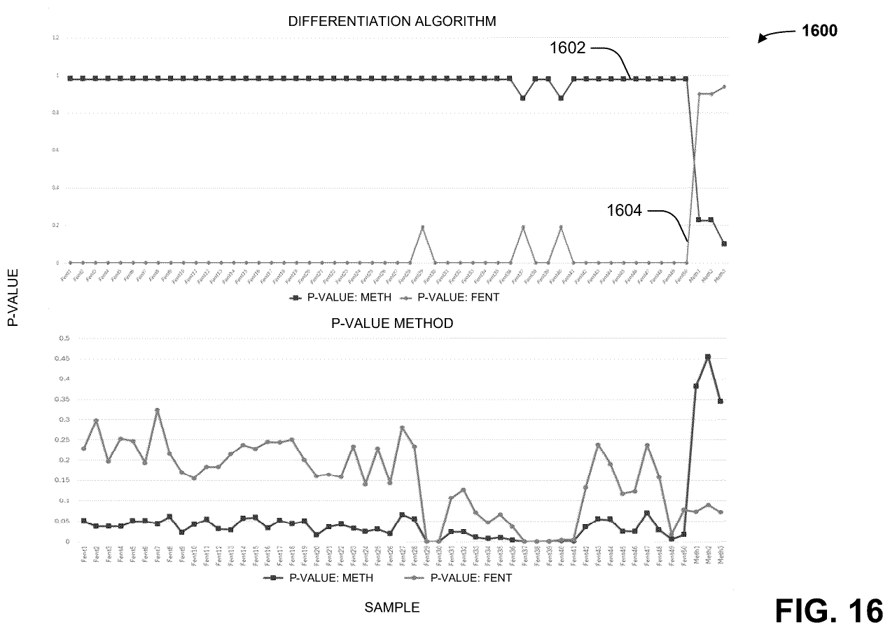

Lastly, consider FIG. 16. FIG. 16 depicts a graph 1600 of experimental results using the various embodiments described herein, a graph 1610 of experimental results using the state-of-the-art existing method on the 160 samples from the first device. In graph 1600 and graph 1610, the x-axis represents the 53 samples from the third device (e.g., 3 methamphetamine samples and 50 fentanyl samples) and the y-axis represents the p-value (e.g., the probability that the sample is methamphetamine or fentanyl).

The various embodiments described herein were applied to the 53 samples twice, identifying if the sample is methamphetamine one time (represented by line 1602), and identifying if the sample is fentanyl a second time (represented by line 1604). As can be seen, the graph 1600 demonstrates high separation margins with high confidence in the identification of the 160 samples. In other words, various embodiments described herein successfully identified all samples from the second device with a high separation margin. Conversely, in graph 1610, the p-values show limited differentiation with low confidence in identification. From the p-value results for the samples of the third device, 10 out of 50 p-values are below 0.05, with 8 of them very close to 0. This suggests that while there are instances where separation is successful, there are also occasions where it fails to distinguish between the two compositions. Thus, in comparison to the state-of-the-art existing method, the various embodiments described herein demonstrate significantly better performance in differentiating spectrally similar compositions to identify the samples.

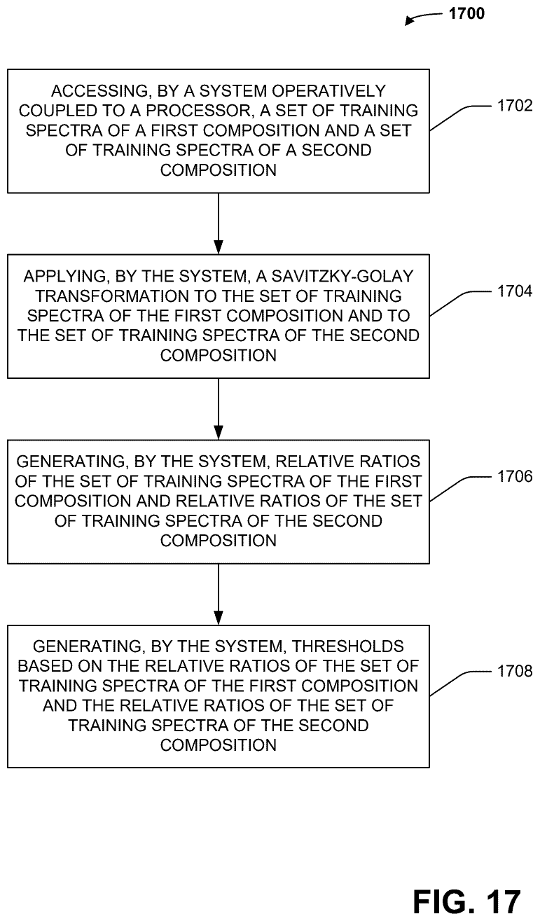

FIG. 17 illustrates a flow diagram of example, non-limiting method 1700 that can facilitate unary differentiation of compositions in accordance with one or more embodiments described herein.

At 1702, non-limiting method 1700 can comprise accessing (e.g., by training component 520), by a system operatively coupled to a processor, a set of training spectra of a first composition and a set of training spectra of a second spectra.

At 1704, non-limiting method 1700 can comprise applying (e.g., by training component 520), by the system, a Savitzky-Golay transformation to the set of training spectra of the first composition and to the set of training spectra of the second spectra.

At 1706, non-limiting method 1700 can comprise generating (e.g., by training component 520), by the system, relative ratios of the set of training spectra of the first composition and relative ratios of the set of training spectra of the second spectra.

At 1708, non-limiting method 1700 can comprise generating (e.g., by training component 520), by the system, thresholds based on the relative ratios of the set of training spectra of the first composition and the relative ratios of the set of training spectra of the second spectra.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 19 and the following discussion are intended to provide a brief, general description of a suitable computing environment 1900 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 19, the example environment 1900 for implementing various embodiments of the aspects described herein includes a computer 1902, the computer 1902 including a processing unit 1904, a system memory 1906 and a system bus 1908. The system bus 1908 couples system components including, but not limited to, the system memory 1906 to the processing unit 1904. The processing unit 1904 can be any of various commercially available processors. Dual microprocessors and other multi-processor architectures can also be employed as the processing unit 1904.

The system bus 1908 can be any of several types of bus structure that can further interconnect to a memory bus (with or without a memory controller), a peripheral bus, and a local bus using any of a variety of commercially available bus architectures. The system memory 1906 includes ROM 1910 and RAM 1912. A basic input/output system (BIOS) can be stored in a non-volatile memory such as ROM, erasable programmable read only memory (EPROM), EEPROM, which BIOS contains the basic routines that help to transfer information between elements within the computer 1902, such as during startup. The RAM 1912 can also include a high-speed RAM such as static RAM for caching data.

The computer 1902 further includes an internal hard disk drive (HDD) 1914 (e.g., EIDE, SATA), one or more external storage devices 1916 (e.g., a magnetic floppy disk drive (FDD) 1916, a memory stick or flash drive reader, a memory card reader, etc.) and a drive 1920, e.g., such as a solid state drive, an optical disk drive, which can read or write from a disk 1922, such as a CD-ROM disc, a DVD, a BD, etc. Alternatively, where a solid state drive is involved, disk 1922 would not be included, unless separate. While the internal HDD 1914 is illustrated as located within the computer 1902, the internal HDD 1914 can also be configured for external use in a suitable chassis (not shown). Additionally, while not shown in environment 1900, a solid state drive (SSD) could be used in addition to, or in place of, an HDD 1914. The HDD 1914, external storage device(s) 1916 and drive 1920 can be connected to the system bus 1908 by an HDD interface 1924, an external storage interface 1926 and a drive interface 1928, respectively. The interface 1924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1912, including an operating system 1930, one or more application programs 1932, other program modules 1934 and program data 1936. All or portions of the operating system, applications, modules, or data can also be cached in the RAM 1912. The systems and methods described herein can be implemented utilizing various commercially available operating systems or combinations of operating systems.

Computer 1902 can optionally comprise emulation technologies. For example, a hypervisor (not shown) or other intermediary can emulate a hardware environment for operating system 1930, and the emulated hardware can optionally be different from the hardware illustrated in FIG. 19. In such an embodiment, operating system 1930 can comprise one virtual machine (VM) of multiple VMs hosted at computer 1902. Furthermore, operating system 1930 can provide runtime environments, such as the Java runtime environment or the .NET framework, for applications 1932. Runtime environments are consistent execution environments that allow applications 1932 to run on any operating system that includes the runtime environment. Similarly, operating system 1930 can support containers, and applications 1932 can be in the form of containers, which are lightweight, standalone, executable packages of software that include, e.g., code, runtime, system tools, system libraries and settings for an application.

Further, computer 1902 can be enable with a security module, such as a trusted processing module (TPM). For instance with a TPM, boot components hash next in time boot components, and wait for a match of results to secured values, before loading a next boot component. This process can take place at any layer in the code execution stack of computer 1902, e.g., applied at the application execution level or at the operating system (OS) kernel level, thereby enabling security at any level of code execution.

A user can enter commands and information into the computer 1902 through one or more wired/wireless input devices, e.g., a keyboard 1938, a touch screen 1940, and a pointing device, such as a mouse 1942. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1904 through an input device interface 1944 that can be coupled to the system bus 1908, but can be connected by other interfaces, such as a parallel port, an IEEE 1394 serial port, a game port, a USB port, an IR interface, a BLUETOOTH® interface, etc.

A monitor 1946 or other type of display device can be also connected to the system bus 1908 via an interface, such as a video adapter 1948. In addition to the monitor 1946, a computer typically includes other peripheral output devices (not shown), such as speakers, printers, etc.

The computer 1902 can operate in a networked environment using logical connections via wired or wireless communications to one or more remote computers, such as a remote computer(s) 1950. The remote computer(s) 1950 can be a workstation, a server computer, a router, a personal computer, portable computer, microprocessor-based entertainment appliance, a peer device or other common network node, and typically includes many or all of the elements described relative to the computer 1902, although, for purposes of brevity, only a memory/storage device 1952 is illustrated. The logical connections depicted include wired/wireless connectivity to a local area network (LAN) 1954 or larger networks, e.g., a wide area network (WAN) 1956. Such LAN and WAN networking environments are commonplace in offices and companies, and facilitate enterprise-wide computer networks, such as intranets, all of which can connect to a global communications network, e.g., the Internet.

When used in a LAN networking environment, the computer 1902 can be connected to the local network 1954 through a wired or wireless communication network interface or adapter 1958. The adapter 1958 can facilitate wired or wireless communication to the LAN 1954, which can also include a wireless access point (AP) disposed thereon for communicating with the adapter 1958 in a wireless mode.

When used in a WAN networking environment, the computer 1902 can include a modem 1960 or can be connected to a communications server on the WAN 1956 via other means for establishing communications over the WAN 1956, such as by way of the Internet. The modem 1960, which can be internal or external and a wired or wireless device, can be connected to the system bus 1908 via the input device interface 1944. In a networked environment, program modules depicted relative to the computer 1902 or portions thereof, can be stored in the remote memory/storage device 1952. It will be appreciated that the network connections shown are example and other means of establishing a communications link between the computers can be used.

When used in either a LAN or WAN networking environment, the computer 1902 can access cloud storage systems or other network-based storage systems in addition to, or in place of, external storage devices 1916 as described above, such as but not limited to a network virtual machine providing one or more aspects of storage or processing of information. Generally, a connection between the computer 1902 and a cloud storage system can be established over a LAN 1954 or WAN 1956 e.g., by the adapter 1958 or modem 1960, respectively. Upon connecting the computer 1902 to an associated cloud storage system, the external storage interface 1926 can, with the aid of the adapter 1958 or modem 1960, manage storage provided by the cloud storage system as it would other types of external storage. For instance, the external storage interface 1926 can be configured to provide access to cloud storage sources as if those sources were physically connected to the computer 1902.

The computer 1902 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 20 is a schematic block diagram of a sample computing environment 2000 with which the disclosed subject matter can interact. The sample computing environment 2000 includes one or more client(s) 2010. The client(s) 2010 can be hardware or software (e.g., threads, processes, computing devices). The sample computing environment 2000 also includes one or more server(s) 2030. The server(s) 2030 can also be hardware or software (e.g., threads, processes, computing devices). The servers 2030 can house threads to perform transformations by employing one or more embodiments as described herein, for example. One possible communication between a client 2010 and a server 2030 can be in the form of a data packet adapted to be transmitted between two or more computer processes. The sample computing environment 2000 includes a communication framework 2050 that can be employed to facilitate communications between the client(s) 2010 and the server(s) 2030. The client(s) 2010 are operably connected to one or more client data store(s) 2020 that can be employed to store information local to the client(s) 2010. Similarly, the server(s) 2030 are operably connected to one or more server data store(s) 2040 that can be employed to store information local to the servers 2030.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM).

Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.
EXAMPLE 1: A system can comprise a processor that can execute computer-executable components stored in a non-transitory computer-readable memory, wherein the computer-executable components can comprise: a conversion component that generates one or more binary features based on a set of transformed peaks of a sample spectrum, the sample spectrum associated with a sample of interest; and an identification component that determines a probability parameter for the sample of interest based on the one or more binary features, wherein the probability parameter is associated with a first target composition.
EXAMPLE 2: The system of any preceding example can be implemented, wherein the conversion component generates a binary feature based on whether a sample ratio and a library ratio meet a corresponding threshold, wherein the sample ratio is associated with a height of a transformed peak of interest of the sample spectrum, and wherein the library ratio is associated with a height of a transformed peak of a library spectrum of the first target composition.
EXAMPLE 3: The system of any preceding example can be implemented, wherein generating the one or more binary features comprises: a determination of the sample ratio by normalizing, based on height, the transformed peak of interest to a base peak of the set of transformed peaks; and a generation of a relative ratio based on the sample ratio and the library ratio.
EXAMPLE 4: The system of any preceding example can be implemented, further comprising a training component that generates, via an entropy method, the corresponding threshold based on a set of training spectra of the first target composition and a set of training spectra of a second target composition.
EXAMPLE 5: The system of any preceding example can be implemented, further comprising a transformation component that applies a Savitzky-Golay (SG) transformation to produce the set of transformed peaks.
EXAMPLE 6: The system of any preceding example can be implemented, wherein the conversion component determines conditional probabilities of the sample containing the first target composition or the second target composition based on the one or more binary features.
EXAMPLE 7: The system of any preceding example can be implemented, wherein generating the corresponding thresholds further comprises: a reception of library spectrum corresponding to one or more additional target compositions; a determination of additional relative ratios between the library spectrum corresponding to the one or more additional target compositions and respective sets of training spectra the one or more additional target compositions; and a generation of, via the entropy method, the corresponding thresholds based on the additional relative ratios.
EXAMPLE 8: The system of any preceding example can be implemented, wherein the conversion component generates the one or more binary features from measured spectra of the sample based on relative ratios meeting predetermined thresholds.
EXAMPLE 9: The system of any preceding example can be implemented, wherein the identification component sums the one or more binary features to determine the probability parameter, and wherein the identification component validates that the sample comprises the first target composition based on the probability parameter.

In various embodiments, any combination or combinations of examples 1-9 can be implemented.
EXAMPLE 10: A computer-implemented method can comprise: generating, by a system operatively coupled to a processor, one or more binary features based on a set of transformed peaks of a sample spectrum, the sample spectrum associated with a sample of interest; and determining, by the system, a probability parameter for the sample of interest based on the one or more binary features, wherein the probability parameter is associated with a first target composition.
EXAMPLE 11: The computer-implemented method of any preceding example can be implemented, further comprising generating, by the system, a binary feature based on whether a sample ratio and a library ratio meet a corresponding threshold, wherein the sample ratio is associated with a height of a transformed peak of interest of the sample spectrum, and wherein the library ratio is associated with a height of a transformed peak of a library spectrum of the first target composition.
EXAMPLE 12: The computer-implemented method of any preceding example can be implemented, wherein generating the one or more binary features comprises: determining the sample ratio by normalizing, based on height, the transformed peak of interest to a base peak of the set of transformed peaks; and generating a relative ratio based on the sample ratio and the library ratio.
EXAMPLE 13: The computer-implemented method of any preceding example can be implemented, further comprising generating, by the system, via an entropy method, the corresponding threshold based on a set of training spectra of the first target composition and a set of training spectra of a second target composition.
EXAMPLE 14: The computer-implemented method of any preceding example can be implemented, further comprising applying, by the system, a Savitzky-Golay (SG) transformation to produce the set of transformed peaks.
EXAMPLE 15: The computer-implemented method of any preceding example can be implemented, further comprising determining, by the system, conditional probabilities of the sample containing the first target composition or the second target composition based on the one or more binary features.
EXAMPLE 16: The computer-implemented method of any preceding example can be implemented, further comprising receiving, by the system, library spectrum corresponding to one or more additional target compositions.
EXAMPLE 17: The computer-implemented method of any preceding example can be implemented, further comprising summing, by the system, the one or more binary features to determine the probability parameter; and validating, by the system, that the sample comprises the first target composition based on the probability parameter.

In various embodiments, any combination or combinations of examples 10-17 can be implemented.
EXAMPLE 18: A computer program product for facilitating unary differentiation of compositions can comprise a non-transitory computer-readable memory having program instructions embodied therewith. In various aspects, the program instructions can be executable by a processor to cause the processor to: generate, by the processor, one or more binary features based on a set of transformed peaks of a sample spectrum, the sample spectrum associated with a sample of interest; and determine, by the processor, a probability parameter for the sample of interest based on the one or more binary features, wherein the probability parameter is associated with a first target composition.
EXAMPLE 19: The computer program product of any preceding example can be implemented, wherein the processor can generate, by the processor, a binary feature based on whether a sample ratio and a library ratio meet a corresponding threshold, wherein the sample ratio is associated with a height of a transformed peak of interest of the sample spectrum, and wherein the library ratio is associated with a height of a transformed peak of a library spectrum of the first target composition.
EXAMPLE 20: The computer program product of any preceding example can be implemented, wherein generating the one or more binary features comprises: determining the sample ratio by normalizing, based on height, the transformed peak of interest to a base peak of the set of transformed peaks; and generating a relative ratio based on the sample ratio and the library ratio.

In various embodiments, any combination or combinations of examples 18-20 can be implemented.

In various embodiments, any combination or combinations of examples 1-20 can be implemented.

What is claimed is:

1. A system, comprising:
a memory that stores computer executable components; and
a processor that executes the computer executable components stored in the memory, wherein the computer executable components comprise:
a conversion component that generates one or more binary features based on a set of transformed peaks of a sample spectrum, the sample spectrum associated with a sample of interest; and
an identification component that determines a probability parameter for the sample of interest based on the one or more binary features, wherein the probability parameter is associated with a first target composition.

2. The system of claim 1, wherein the conversion component generates a binary feature based on whether a sample ratio and a library ratio meet a corresponding threshold, wherein the sample ratio is associated with a height of a transformed peak of interest of the sample spectrum, and wherein the library ratio is associated with a height of a transformed peak of a library spectrum of the first target composition.

3. The system of claim 2, wherein generating the one or more binary features comprises:
a determination of the sample ratio by normalizing, based on height, the transformed peak of interest to a base peak of the set of transformed peaks; and
a generation of a relative ratio based on the sample ratio and the library ratio.

4. The system of claim 2, further comprising:
a training component that generates, via an entropy method, the corresponding threshold based on a set of training spectra of the first target composition and a set of training spectra of a second target composition.

5. The system of claim 1, further comprising:
a transformation component that applies a Savitzky-Golay (SG) transformation to produce the set of transformed peaks.

6. The system of claim 4, wherein the conversion component determines conditional probabilities of the sample containing the first target composition or the second target composition based on the one or more binary features.

7. The system of claim 4, wherein generating corresponding thresholds comprises:
a reception of library spectrum corresponding to one or more additional target compositions;
a determination of additional relative ratios between the library spectrum corresponding to the one or more additional target compositions and respective sets of training spectra the one or more additional target compositions; and
a generation of, via the entropy method, the corresponding thresholds based on the additional relative ratios.

8. The system of claim 3, wherein the conversion component generates the one or more binary features from measured spectra of the sample based on relative ratios meeting predetermined thresholds.

9. The system of claim 1, wherein the identification component sums the one or more binary features to determine the probability parameter, and wherein the identification component validates that the sample comprises the first target composition based on the probability parameter.

10. A computer-implemented method, comprising:
generating, by a system operatively coupled to a processor, one or more binary features based on a set of transformed peaks of a sample spectrum, the sample spectrum associated with a sample of interest; and
determining, by the system, a probability parameter for the sample of interest based on the one or more binary features, wherein the probability parameter is associated with a first target composition.

11. The computer-implemented method of claim 10, further comprising:
generating, by the system, a binary feature based on whether a sample ratio and a library ratio meet a corresponding threshold, wherein the sample ratio is associated with a height of a transformed peak of interest of the sample spectrum, and wherein the library ratio is associated with a height of a transformed peak of a library spectrum of the first target composition.

12. The computer-implemented method of claim 11, wherein generating the one or more binary features comprises:
determining the sample ratio by normalizing, based on height, the transformed peak of interest to a base peak of the set of transformed peaks; and
generating a relative ratio based on the sample ratio and the library ratio.

13. The computer-implemented method of claim 11, further comprising:
generating, by the system, via an entropy method, the corresponding threshold based on a set of training spectra of the first target composition and a set of training spectra of a second target composition.

14. The computer-implemented method of claim 10, further comprising:
applying, by the system, a Savitzky-Golay (SG) transformation to produce the set of transformed peaks.

15. The computer-implemented method of claim 13, further comprising:
determining, by the system, conditional probabilities of the sample containing the first target composition or the second target composition based on the one or more binary features.

16. The computer-implemented method of claim 13, wherein generating corresponding thresholds comprises:
receiving, by the system, library spectrum corresponding to one or more additional target compositions;
determining, by the system, additional relative ratios between the library spectrum corresponding to the one or more additional target compositions and respective sets of training spectra the one or more additional target compositions; and
generating, by the system, via the entropy method, the corresponding thresholds based on the additional relative ratios.

17. The computer-implemented method of claim 10, further comprising:
summing, by the system, the one or more binary features to determine the probability parameter; and
validating, by the system, that the sample comprises the first target composition based on the probability parameter.

18. A computer program product for unary composition differentiation, the computer program product comprising a computer readable storage medium having program instructions embodied therewith, the program instructions executable by a processor to cause the processor to:
generate, by the processor, one or more binary features based on a set of transformed peaks of a sample spectrum, the sample spectrum associated with a sample of interest; and
identify, by the processor, a probability parameter for the sample of interest based on the one or more binary features, wherein the probability parameter is associated with a first target composition.

19. The computer program product of claim 18, wherein the program instructions executable by the processor further cause the processor to:
generate, by the processor, a binary feature based on whether a sample ratio and a library ratio meet a corresponding threshold, wherein the sample ratio is associated with a height of a transformed peak of interest of the sample spectrum, and wherein the library ratio is associated with a height of a transformed peak of a library spectrum of the first target composition.

20. The computer program product of claim 19, wherein generating the one or more binary features comprises:
determining the sample ratio by normalizing, based on height, the transformed peak of interest to a base peak of the set of transformed peaks; and
generating a relative ratio based on the sample ratio and the library ratio.
